(19) United States
(12) Patent Application Publication
(10) Pub. No.: US 2020/0183429 A1
(43) Pub. Date: Jun. 11, 2020

(54) REMOTE OBJECT CAPTURE

(71) Applicant: Ottenheimers, Inc., Madison, WI (US)

(72) Inventor: Afan Ottenheimer, Madison, WI (US)

(73) Assignee: Ottenheimers, Inc., Madison, WI (US)

(21) Appl. No.: 16/638,274

(22) PCT Filed: Aug. 15, 2018
(86) PCT No.: PCT/IB2018/056146

§ 371 Date: Feb. 11, 2020

Related U.S. Application Data
(60) Provisional application No. 62/545,697, filed on Aug. 15, 2017.

(51) Int. Cl. G05D 1/10; F41H 11/02; B64C 39/02

(52) U.S. Cl. CPC G05D 1/104; F41H 11/02; B64C 2201/12; B64C 2201/145; B64C 2201/143; B64C 39/024

(57) ABSTRACT

Provided herein is technology related to embodiments of methods, systems, and apparatuses for deploying a drone swarm to target and/or capture remote objects through the use of a rotating subset of the drone swarm with nodes configured to detect emitted or reflected signals from the remote object or by observing the visual appearance of the remote object.

This application claims priority to U.S. provisional patent application Ser. No. 62/545,697, filed Aug. 15, 2017, which is incorporated herein by reference in its entirety.

### FIELD

Provided herein is technology relating to coordinating a group of autonomous vehicles comprising an entanglement device to capture or impede remote objects and particularly, but not exclusively, to methods, apparatuses, and systems for targeting and capturing objects using a drone swarm.

### BACKGROUND

An issue of concern to public (e.g., governments) and private (e.g., businesses) entities is the ability to locate and intercept remote objects such as birds near airports, insects near crops, drones that enter restricted air space, or drones used for commercial espionage or surveillance. Some current solutions to these and related problems include propelling physical objects at the remote objects, or using sound or electromagnetic pulses to disable the remote objects. Both solutions usually require a clear line of sight. New technologies are needed to identify, target, and possibly disable or capture remote objects.

### SUMMARY

Accordingly, provided herein is technology related to embodiments of methods, systems, and apparatuses for deploying a drone swarm to target and/or capture remote objects, e.g., by using a rotating subset of the drone swarm with nodes configured to detect emitted or reflected signals from the remote object or by observing the visual appearance of the remote object.

Conventional detection systems comprise devices with an aggregation of sensors that act together to achieve greater precision and sensitivity for sensing remote objects. For example, telescopes in an array can use interferometry to achieve greater precision in the resolving and triangulation of distant objects, such as the Very Long Baseline Array (VLBA) telescope system. Another example of aggregating sensors for identifying position and velocity is triangulation from RADAR stations in which increased numbers and separation of detectors allows for increased resolution of identifying a location of another object, e.g. a remote object. Another example of aggregating sensors is signal triangulation in which increased separation of detectors allows for increased resolution of identifying a location of another object emitting a known frequency. Another example of aggregating sensors for identifying position and velocity is Doppler shift analysis where one can determine the direction of a remote emitting or reflecting source by moving a fixed array of detectors.

In contrast to the above technologies, which all consist of sensors fixed in place relative to each other, a drone swarm equipped with sensing nodes provides a technology that combines aggregate detection and triangulation utilizing non-fixed in place sensors, combined with coordinated movement to allow drones in a drone swarm to move closer and/or change their orientation relative to a remote object for greater resolution and tracking. Since sensors on a drone can get increasingly better accuracy as a drone closes in on another object, using a large number of drones also provides the possibility of safely capturing remote objects autonomously. Accordingly, provided herein is a technology related to a drone swarm system comprising aggregate detection and triangulation methods with capturing methods. In some embodiments, the technology provides a drone swarm system comprising aggregate detection and triangulation methods and an entanglement device (e.g. a net) strung between a subset of drones of the drone swarm to capture or impede a remote object.

For clarity, throughout the application, a singular drone that is part of a drone swarm will be referred to as a drone and one or more drones that are part of a drone swarm will be referred to as drones. For further clarity, in this application, the feature that allows the drones to sense and communicate simultaneously is called a “node.” The node could be attached to a drone as a separate unit, a unit connected to a drone directly via cables (network, power, general-IO, etc.), or an integral part of a drone built in as components.

An embodiment of the present application is a system for locating a remote object. The system includes a drone swarm, which includes a plurality of drones where at least two drones of the plurality of drones includes a node (hereinafter “sensing drones”). In a different implementation of the system, the system includes a drone swarm, wherein at least two drones of the plurality of drones in the swarm are sensing drones, and a central coordinating station.

Another embodiment of the present application is a system for locating and capturing a remote object. The system includes a drone swarm, wherein at least two drones of the plurality of drones in the swarm are sensing drones and at least two drones in the plurality of drones are capable of carrying an entanglement device (herein after “entanglement drones”), and an entanglement device. In a different implementation of the system, the system includes a drone swarm, wherein at least two drones of the plurality of drones in the swarm are sensing drones and at least two drones of the plurality of drones in the swarm are entanglement drones, an entanglement device, and a central coordinating station. It should be understood that a sensing drone can also be an entanglement drone and that an entanglement drone can also be a sensing drone.

Another embodiment of the present application is a method for locating a remote object. A drone swarm, including at least two sensing drones, configured to locate remote objects is provided. The drone swarm autonomously searches for remote objects. At least one of the sensing drones detects a remote object. The sensing drones communicate the location information of the detected remote object. In another implementation of the method, a drone swarm, including at least two sensing drones, configured to locate remote objects is provided. A central processing station is configured to communicate with the drone swarm and provides instructions to the drone swarm to search for remote objects. At least one of the sensing drones detects a remote object. The sensing drones communicate the location information of the detected remote object to the central processing station. The central processing station provides further instruction to the drone swarm on how to operate.

Another embodiment of the present application is a method for locating and capturing/impeding a remote object. A drone swarm, including at least two sensing drones and at least two entanglement drones, configured to locate and capture/impede remote objects is provided. The entanglement drones are equipped with an entanglement device. The drone swarm autonomously searches for remote objects. At least one of the sensing drones detects a remote object. The sensing drones communicate the location information of the detected remote object to the drone swarm. The drone swarm autonomously continues to detect and autonomously captures/impedes the remote object in the entanglement device. In another implementation of the method, a drone swarm, including at least two sensing drones and at least two entanglement drones, configured to locate and capture/impede remote objects is provided. A central processing station is configured to communicate with the drone swarm and provides instructions to the drone swarm to search for remote objects. At least one of the sensing drones detects a remote object. The sensing drones communicate the location information of the detected remote object to the central processing station. The central processing station provides further instructions to the drone swarm to continue detecting the remote object and capture/impede the remote object with the entanglement device. The drone swarm continues to track and capture/impede the remote object.

In the above embodiments, the drone swarm includes a plurality of drones wherein the drones may be unmodified drones, sensing drones, and/or entanglement drones. It should be understood that the embodiments of the drones are not exclusive and that a sensing drone can also be an entanglement drone and vice versa, among other potential combinations of drone types. In embodiments where the drone swarm is configured to locate a remote object the drone swarm includes at least two sensing drones. In embodiments where the drone swarm is configured to locate and capture a remote object the drone swarm includes at least two sensing drones and at least two entanglement drones.

The technology is not limited in the number of drones in the drone swarm. For instance, in some embodiments the drone swarm comprises 2 to 50 drones. In some embodiments, the drone swarm comprises 2, 3, 4, 5, 6, 7, 8, 9, 10, 11, 12, 13, 14, 15, 16, 17, 18, 19, 20, 21,22, 23, 24, 25, 26, 27, 28, 29, 30, 31, 32, 33, 34, 35, 36, 37, 38, 39, 40, 41, 42, 43, 44, 45, 46, 47, 48, 49, or 50 or more drones (e.g., 60, 70, 80, 90, or 100 or more drones). In some embodiments, the drone swarm includes subsets of drones. The technology is not limited in the number of drones in a subset of the drone swarm; accordingly, a subset of drones of the drone swarm includes, in some embodiments, any number of drones up to one fewer than the total number of drones in the drone swarm. For example, a subset comprises, in some embodiments, 1, 2, 3, 4, 5, 6, 7, 8, 9, 10, 11, 12, 13, 14, 15, 16, 17, 18, 19, 20, 21,22, 23, 24, 25, 26, 27, 28, 29, 30, 31, 32, 33, 34, 35, 36, 37, 38, 39, 40, 41, 42, 43, 44, 45, 46, 47, 48, 49, or 50 or more drones (e.g., 60, 70, 80, 90, or 100 or more drones), depending on the number of drones in the drone swarm. A subset of drones in the drone swarm, in some embodiments, is configured to provide a particular function to the system. For example, a subset of drones may include sensing drones only, may include entanglement drones only, may include unmodified drones only, or may include any combination of different drone types.

The technology is not limited in the number of subsets of drones in the drone swarm. In some embodiments, the drone swarm comprises 1 to 10 subsets of drones (e.g., 1, 2, 3, 4, 5, 6, 7, 8, 9, or 10 or more subsets). Subsets of drones may overlap. Accordingly, in some embodiments a drone may be a member of more than one subset and thus provide multiple functions to the drone swarm. In some embodiments, the members of a subset may completely overlap. In some embodiments, a member of a subset is not a member of another subset.

In the embodiments indicated above, a sensing drone includes a node that enables the sensing drone to locate, track, and communicate about remote objects and other drones. The node includes a sensing antenna and a network antenna. In some embodiments, the node comprises a computing module, an energy storage device, a global positioning system (GPS) device, and/or additional sensors in addition to the sensing antenna and network antenna. The additional sensors may include, for example, magnetic, thermal, optical (e.g., image, camera), sound (e.g., microphone), accelerometer, radioactivity, biological, chemical, or another sensor as described herein. In some embodiments, the node includes an additional sensor to detect a particular signal, such as an electromagnetic wave or a radio frequency in addition to the sensing antenna and network antenna. Furthermore, in some embodiments the node includes a processor configured to produce a signal detection packet and/or to transmit a signal detection packet (e.g., by the network antenna) in addition to the sensing antenna and network antenna. It should be understood that the above are merely examples of embodiments of the node and other embodiments are considered to be within the scope of the description. In some embodiments, the sensor detects an 802.11 b/g/n signal (e.g., a 2.4 GHz signal).

In particular embodiments, the technology relates to a node comprising a processor configured to perform Doppler frequency shift analysis, e.g., using: i) data collected by said sensing antenna; and data describing the position and/or movement of said node. And, in some embodiments, the node comprises a processor configured to measure a change in a magnitude of a detected signal or a shift in frequency of a detected signal.

In some embodiments, a node is configured to transmit location data describing the position of said node. In some embodiments, a node is configured to transmit location data describing the position of another node. In some embodiments, a node is configured to transmit location data describing the position of a remote object and/or velocity data describing the velocity of the remote object.

As can be seen by the above embodiments of the node, a node can be configured to autonomously provide instructions to the drone on locating, tracking, and coordinating capture/impediment of remote objects. As an alternative, a node can be configured to receive instructions from a central coordinating station on locating, tracking, and coordinating capture of remote objects. A node can be configured to communicate with other nodes, other drones, and/or a central coordinating station.

In embodiments that include entanglement drones, the system may also include an entanglement device carried/contained on an entanglement drone or a subset thereof. The entanglement device can be any device that the entanglement drone is configured to carry, such as a net, fabric, string, thread, balloon, cord, mesh, snare, loop, or other entanglement device.

A drone can be equipped to carry an entanglement device by altering the body of the drone to allow an entanglement device to be attached to it such that the entanglement device is kept out of the moving parts of the drone. In a drone that flies through the air, this might be as simple as a stiff strut that firmly attaches to the body of the drone with a hole at the far end for attaching the entanglement device. With multiple drones carrying the entanglement device at a fixed distance from each other, it allows the entanglement device to be carried such that the entanglement device does not swing relative to any one drone and thus be carried without getting into the moving parts of a drone even while the subset of the drones in the drone swarm move quickly and/or change directions.

In embodiments that do not include a central coordinating station, drones, including sensing drones and entanglement drones, in the drone swarm are configured to communicate and coordinate operations regarding locating, tracking, and capture/impediment of remote objects within the drone swarm.

In some embodiments, the system further comprises a central coordinating station, to provide instructions to the drone swarm such as coordinate movement of the drones and/or to provide information (e.g., describing one or more of the drones and/or nodes and/or the object to be captured). In some embodiments, the central coordinating station coordinates drone movement so that the drones move in a geometric pattern (e.g., a two-dimensional pattern (e.g., a circle, oval, ellipse, polygon, line, etc.) or a three-dimensional pattern (e.g., a sphere, spheroid, ellipsoid, etc.) or to carry an entanglement device without interfering with the movement of drones in the drone swarm (e.g., entangling themselves). For example, in some embodiments the central coordinating station receives data, information, and/or signals from one or more drones and/or nodes of the drone swarm and in some embodiments the central coordinating station transmits data, information, and/or signals to one or more drones and/or nodes of the drone swarm. In some embodiments, the central coordinating station transforms received data or performs a calculation and transmits a result of the transformation or calculation to one or more drones of the drone swarm.

In some embodiments, the position and/or orientation of a drone or remote object is described by a location (e.g., coordinates in space such as GPS coordinates), velocity (e.g., speed and direction), orientation (e.g., pitch, roll, yaw), acceleration, or other mathematical or mechanical descriptors. In some embodiments, instructions are provided to one or more drones to cause a change in position and/or orientation of the drone relative to said drone, relative to a fixed point, relative to a source of a signal, relative to another drone, or relative to the remote object.

In some embodiments, a network provides communications between or amongst drones and/or nodes in a drone swarm and/or provides communications between drones or nodes with a central coordinating station. Thus, in some embodiments, the drone swarm comprises one or more networks connecting drones and/or nodes of the drone swarm and/or a central coordinating station.

In some embodiments, the system comprises a plurality of computer processors, a plurality of computer memories, a plurality of networking communications modules, and a central coordinating station networked to the set of computer processors, wherein the computer processors are configured to perform instructions provided by a computer program stored in the computer memories to control one or more drones. For example, the drone swarm (or a subset thereof that are sensing drones) may be instructed to fly in a geometric pattern for aggregate remote object detection. In some embodiments, each drone is controlled by specifying a velocity for the drone. In some embodiments, the velocities of the entanglement drones are provided by said computer program to position the drones and entanglement device without entangling a drone in the entanglement device. In some embodiments, a central coordinating system is configured to process data returned by a subset of drones to determine the location of the remote object to be captured relative to the entanglement device. In some embodiments, the subset of drones is programmed by the computer program to direct the area of the entanglement device toward the remote object to be captured.

Communication can flow from drone and/or nodes to a central coordinating station and also in the opposite direction. The central coordinating station can keep track of where drones are and relay that information back to other drones which might be too far apart to share that information directly. If one node detects a remote object and sends that information to a central coordinating station, the central coordinating station can direct drones to react accordingly and in sync.

Embodiments of methods for locating remote objects, as indicated above, utilize the system embodiments described herein. In an exemplary embodiment for the method of locating a remote object, a drone swarm is deployed. As indicated above, the drone swarm includes at least two sensing drones, with embodiments as described above. The drone swarm (or a subset thereof) is configured to search for and locate remote objects. For example, the drone swarm (or a subset thereof) may be instructed to move in a geometric pattern (e.g., a two-dimensional pattern (e.g., a circle, oval, ellipse, polygon, line, etc.) or a three-dimensional pattern (e.g., a sphere, spheroid, ellipsoid, etc.) to search for remote objects in an area. The area may be predefined or dynamically defined. A sensing drone detects a remote object. It should be understood that the remove object may be detected by any one or more of the sensing drones in the drone swarm. It should further be understood that the sensing drones may detect the remote object through any one or more of the sensing abilities described above. For example, the sensing drone may detect signals emitted or reflected from a remote object or may have a camera sensor and visually determine the detection of a remote object. Once a remote object is detected, said detection is communicated to the system.

Sensing drones continue to track the detected remote object using the sensors of the sensing drone. For example, simultaneous measurements of signal strength or measured Doppler shift and the known position and speed of each sensing drone, allows for the determination of a direction and distance to the remote object with faster speed and greater accuracy than could be achieved with other methods.

In some embodiments, the position and/or orientation of a drone or remote object is described by a location (e.g., coordinates in space such as GPS coordinates), velocity (e.g., speed and direction), orientation (e.g., pitch, roll, yaw), acceleration, or other mathematical or mechanical descriptors. In some embodiments, instructions are provided to one or more drones to cause a change in position and/or orientation of the drone relative to said drone, relative to a fixed point, relative to a source of a signal, relative to another drone, or relative to the remote object.

In some embodiments, nodes (a subset or all) are configured to use frequency Doppler shift detection as described in more detail hereinbelow to determine the velocity and/or location of a remote object. In some embodiments, nodes (a subset or all) are configured to use signal magnitude detection to determine the velocity and/or location of a remote object. The location and/or velocity or speed of the drones and the frequencies detected that are emitted and/or reflected from the object are used for frequency Doppler shift analysis. Said Doppler shift analysis can be used to determine the location and/or velocity of the object, e.g., an object to be located and/or captured. In some embodiments, the system comprises a central coordinating station configured to triangulate the position of a remote object using data provided by a plurality of nodes.

In related embodiments, methods of tracking remote objects are provided. For example, in some embodiments of said methods, a method comprises receiving a device identifier, position, speed, and direction from a first drone. Some embodiments further comprise receiving sensor data associated with the device identifier that contains a detected frequency. In some embodiments, methods further comprise inputting to a central coordinating station a device identifier, position, speed, and/or direction of one or more drones; and an audio or electronic frequency signal emitted or reflected by the remote object and detected by a subset of the nodes; and calculating the position of the remote object using the detected signals and Doppler shift triangulation. In some related embodiments, methods comprise inputting to a central coordinating station a device identifier, position, speed, and/or direction of one or more nodes; and optical, image, or video data describing the position of the remote object observed by a subset of the nodes; and calculating the position of the remote object using the optical, image, or video data and sight triangulation. In some embodiments, methods further comprise transmitting information describing the location of the remote object to a display wherein device identifiers comprise a media access control address.

In embodiments for methods that do not include a central coordinating station, it should be understood that the instructions for detecting, locating, and communicating will be carried out autonomously by the drones in the drone swarm which, as described above, are configured to perform such actions. In embodiments for methods that include a central coordinating station, it should be understood that the instructions for detecting, locating, and communicating will be carried out by the central coordinating station (either autonomously, dynamically, or a combination of both) and transmitted to the drone swarm. It should also be understood that where a central coordinating station is included the instructions may be carried out by a combination of the central coordinating station and the drone swarm.

Embodiments of methods for locating and capturing/impeding remote objects, as indicated above, utilize the system embodiments described herein. In an exemplary embodiment for the method of locating a remote object, a drone swarm is deployed. As indicated above, the drone swarm includes at least two sensing drones and at least two entanglement drones, with embodiments as described above, and an entanglement device carried by the entanglement drones. The drone swarm (or a subset thereof) is configured to search for and locate remote objects. For example, the drone swarm (or a subset thereof) may be instructed to move in a geometric pattern (e.g., a two-dimensional pattern (e.g., a circle, oval, ellipse, polygon, line, etc.) or a three-dimensional pattern (e.g., a sphere, spheroid, ellipsoid, etc.) to search for remote objects in an area. The area may be predefined or dynamically defined. A sensing drone detects a remote object. It should be understood that the remove object may be detected by any one or more of the sensing drones in the drone swarm. It should further be understood that the sensing drones may detect the remote object through any one or more of the sensing abilities described above. For example, the sensing drone may detect signals emitted or reflected from a remote object or may have a camera sensor and visually determine the detection of a remote object. Once a remote object is detected, said detection is communicated to the system.

With an entanglement device (e.g. a net) strung between at least a subset of the entanglement drones, the entanglement drones are directed to capture said object. In some embodiments, as a subset of drones in the drone swarm travel toward the object to be captured, another subset of drones in the drone swarm continue to monitor the detected signals from said object. In some embodiments, a subset of nodes in the drone swarm have additional sensors (e.g., a microphone, a camera, etc.) to gain increasing positional awareness of the remote object. In some embodiments, the subset of drones carrying the entanglement device in the drone swarm are directed toward the remote object. Once the subset of drones in the drone swarm carrying the entanglement device has entangled the object, in some embodiments the subset of the subset of drones in the drone swarm carrying the entanglement device are directed to move to another location (e.g., to a location for the safe deposition of the remote object; to a landing area; etc.) with the captured object and/or to drop the entangled object.

Communication can flow from drone and/or nodes to a central coordinating station and also in the opposite direction. The central coordinating station can keep track of where drones are and relay that information back to other drones which might be too far apart to share that information directly. If one node detects a remote object and sends that information to a central coordinating station, the central coordinating station can direct drones to react accordingly and in sync. Thus, in some embodiments, methods comprise transmitting drone position and/or velocity information from a central coordinating station to a different drone of the drone swarm. This embodiment also comprises transmitting the remote object position and/or velocity information from a central coordinating station to a drone of the drone swarm. And, in some embodiments, methods comprise comprising transmitting data describing the location and/or velocity of the remote object to a subset of drones of the drone swarm carrying the entanglement device. And, in yet other embodiments, the methods further comprise instructing the subset of the drone swarm.

Additional embodiments will be apparent to persons skilled in the relevant art based on the teachings contained herein.

### BRIEF DESCRIPTION OF THE DRAWINGS

These and other features, aspects, and advantages of the present technology will become better understood with regard to the following drawings:

FIG. 1 is a diagram of a node in accordance with a representative embodiment of the technology provided herein.

FIG. 2 is a diagram of a simplified node in accordance with a representative embodiment of the technology provided herein.

FIG. 3 is a functional diagram of the node of FIG. 2 in accordance with a representative embodiment of the technology provided herein.

FIG. 4 is a diagram of an overview of a node architecture in accordance with a representative embodiment of the technology provided herein.

FIG. 5 is a flowchart of operations performed by a node in accordance with a representative embodiment of the technology provided herein.

FIG. 6 is a diagram of an overview of a node's signal detection network packet in accordance with a representative embodiment of the technology provided herein.

FIG. 7 is a diagram of a single drone with a node making measurements over time as the node moves relative to the remote object in accordance with a representative embodiment of the technology provided herein.

FIG. 8 is a diagram of an overview of a drone swarm in a 2-dimensional top view of triangulation via Doppler shift measurement in accordance with a representative embodiment of the technology provided herein.

FIG. 9 is a diagram of an overview of a drone swarm in a 3-dimensional side view of triangulation via Doppler shift in accordance with a representative embodiment of the technology provided herein.

FIG. 10 is a diagram of a drone swarm in a 2-dimensional top view of triangulation via magnitude measurement in accordance with a representative embodiment of the technology provided herein.

FIG. 11 is a diagram of a drone swarm in a 3-dimensional side view of triangulation via magnitude measurement in accordance with a representative embodiment of the technology provided herein.

FIG. 12 is an illustration of a representative entanglement capture system, capturing an object in accordance with a representative embodiment of the technology provided herein.

FIG. 13 is a functional diagram of the triangulation calculations made at the central coordinating station from the information returned from the sensing nodes of a drone swarm in accordance with a representative embodiment of the technology provided herein.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DETAILED DESCRIPTION

Conventional drone technologies include uses of drones as individual vehicles to perform surveillance, sensing, or single actions such as delivery or release of payloads. Some related technologies based on multiple drones comprise various methods to achieve geometric shapes, flocking patterns, or drone-drone awareness to avoid collisions or to avoid obstacles. In particular, some technologies comprise use of a drone swarm, which is a system of two or more unmanned aircraft systems (“UAS”) or unmanned aerial vehicles (“UAV”) that are networked and working together under commands from a single controller. While drone swarms are capable of operations that are not possible for a single drone to undertake, the present technology provides new methods and systems relating to drone swarms for identifying, targeting, disabling, and/or capturing a remote object. In some embodiments, the technology relates to coordinating a group of drones (e.g., a drone swarm) comprising an entanglement device to capture or impede a remote object.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control. The section headings used herein are for organizational purposes only and are not to be construed as limiting the described subject matter in any way.

### Definitions

To facilitate an understanding of the present technology, a number of terms and phrases are defined below. Additional definitions are set forth throughout the detailed description.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator and is equivalent to the term “and/or” unless the context clearly dictates otherwise. The term “based on” is not exclusive and allows for being based on additional factors not described, unless the context clearly dictates otherwise. In addition, throughout the specification, the meaning of “a”, “an”, and “the” include plural references. The meaning of “in” includes “in” and “on.”

As used herein, a “remote object” refers to an object that is identified, located, and optionally targeted for capture by a drone swarm according to embodiments of the technology as described herein. While in some embodiments, a “remote object” can be a drone, the term “remote object” is not limited to a drone and is intended to refer to any object targeted for capture. For example, in some embodiments, a “remote object” is an animal (e.g., a bird, mammal, insect, etc.), an autonomous aircraft, a user-controlled aircraft, a missile to be intercepted, a satellite, etc.

As used herein, an “emitting object” or “reflecting object” refers to an object that emits or reflects a detectable signal. For example, in some embodiments an “emitting object” is detected by detecting the signals emitted by the object; in some embodiments a “reflecting object” is detected by detecting a signal reflected by the object. Non-limiting examples of technologies comprising reflecting a signal off an object include RADAR, SONAR, and LIDAR; non-limiting examples of detecting an emitting object include detecting EM radiation or detecting sound emissions with microphones. In some embodiments, an object is detected by viewing the object as illuminated by the sun, other light sources, or by sources of electromagnetic radiation providing particular wavelengths or ranges of wavelengths in the visible, infrared, and/or ultraviolet regions.

As used herein, a “drone” is an unmanned object capable of 3-dimensional movement through air, water, or the vacuum of space (e.g., an autonomous vehicle that is capable of movement in three spatial dimensions). In some embodiments, a drone is remotely controlled; in some embodiments, a drone is autonomous. In some embodiments, a drone is also capable of movement on land. As used herein, a “drone” is a singular drone that is part of a drone swarm.

As used herein, a “drone swarm” is a plurality of drones that acts as a unit of drones. A drone swarm may be configured to act autonomously or may be configured to be controlled using a central coordinating station. As used herein, a “subset” of a drone swarm comprises a number of drones less than the number of drones in the drone swarm. A drone swarm may have a plurality of subsets, each subset comprising the same or different number of drones. In some embodiments, subsets of a drone swarm provide a particular function for the drone swarm.

As used herein, a “node” is the feature that allows the drone to sense and communicate (as disclosed above a sensing drone). The node could be attached to a drone as a separate unit, a unit connected to a drone directly via cables (network, power, general-IO, etc.), or an integral part of a drone built in as components.

As used herein a “central coordinating station” is one or more computers that control a drone swarm, process signals sent from a drone swarm, and provide an interface for operators to direct a drone swarm. In some embodiments, a central coordinating station comprises a computer that handles all tasks; in some embodiments, a central coordinating station comprises multiple computers and each computer is dedicated to perform one or more specific tasks such as, e.g., triangulation. In some embodiments, computers in a “central coordinating station” are networked together for complete autonomous behavior or rely on a human as a bridge between remote object sensing and movement.

As used herein, an “entanglement device” is one or more objects that is/are carried by drones in a drone swarm (as disclosed above an entanglement drone) or released from a drone swarm to impede movement of a remote object. While in some embodiments, an entanglement device is a net, the term “entanglement device” is not limited to nets and could be customized for particular types of remote objects. For example, if a remote object is propeller driven, an “entanglement device” may comprise long strings with weights that are individually carried by members of a drone swarm. As another non-limiting example, if a remote object is wheel driven, an “entanglement device” may comprise strips of sticky or spiked strips designed to impede wheel operation. It should be understood that the entanglement drones can be configured to carry a particular type of entanglement device based on the anticipated type of remote object to be encountered.

As used herein, the term “electromagnetic wave” is used in accordance with its usage in the art and thus refers to any portion (e.g., particular wavelength or range of wavelengths) of the electromagnetic spectrum. Accordingly, the term “electromagnetic wave” describes forms of waves also known as, e.g., radio waves (e.g., a radio frequency, a radio frequency band, or one or more ranges of radio frequencies), microwaves, infrared radiation, visible light (e.g., visible light at a particular wavelength or range of wavelengths), ultraviolet radiation, X-rays, and gamma rays. In some embodiments, an electromagnetic wave is coherent, e.g., light produced by a laser.

### DESCRIPTION

The technology described herein provides embodiments of methods, systems, and apparatuses for sensing, locating, disabling, and/or capturing a remote object using a drone swarm.

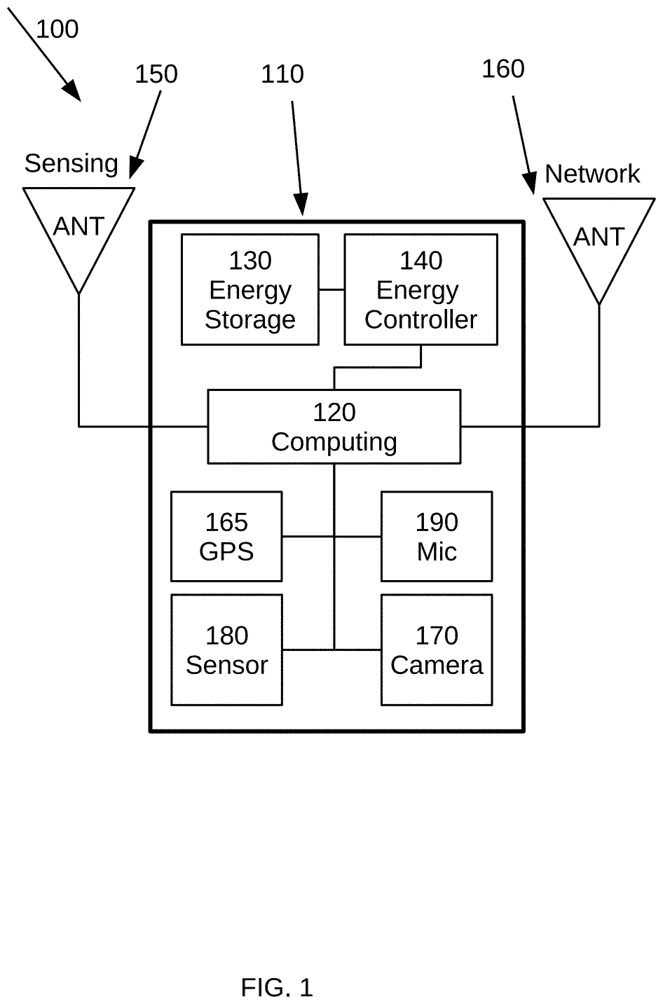

Referring to FIG. 1, a diagram of a node 100 in accordance with a representative embodiment is shown. The depicted embodiment of the node 100 comprises, one or more computing modules 120, an energy storage device 130, an energy controller 140, a sensing antenna 150, and a network antenna 160. The node 100 optionally includes a global positioning system (GPS) device 165, a sensor 180, a camera 170, and a microphone 190. The computing module 120, energy storage device 130, and energy controller 140 are contained in a protective enclosure 110.

The technology is not limited in the materials used for the protective enclosure 110. For example, in some embodiments, the protective enclosure 110 is weatherproof (e.g., a NEMA-4 rated enclosure). In some embodiments, the protective enclosure 110 is made from, carbon fiber or plastic. In some embodiments the antennae 150 and 160 are also enclosed in the protective enclosure 110. In some embodiments, the protective enclosure 110 encloses just the node 100, in other embodiments, the enclosure 110 surrounds both the node 100 along with other components of the drone, such as motors, power distribution unit, etc.

In some embodiments, the node 100 is approximately the size of a deck of standard-sized playing cards or smaller (e.g., less than 10 cm (e.g., less than 9, 8, 7, 6, 5, 4, 3, 2, or 1 cm) in each linear dimension). In some embodiments, the node 100 is operable even when there is no power sent to the other components of the drone (not shown).

In some embodiments, the computing module 120 is a printed circuit board comprising processors, memory, input/output modules, storage devices, transmitters, receivers, controllers, integrated antennae, antennae connectors, and/or slots. In some embodiments, the slots may be used to add or upgrade modules or other features such as detectors, machine vision processors, and human interfaces such as speakers, screens, or LED blinking lights. It should be understood that the above elements of a circuit board are merely exemplary and may include more elements than listed or may not include all of the elements listed.

Energy storage device 130 provides power to the node 100. Energy controller 140 controls recharging of the energy storage device 130 and regulates power to the computing module 120 and other components in the node 100. The energy controller 140 could be, for example, the MPS® MP2615 (Monolithic Power Systems, Inc., Kirkland, Wash.), a switch mode battery charger. The technology is not limited in the energy storage device 130 used. For example, in some embodiments, the energy storage device 130 is a battery, such as a 9-volt, 15 Ah lithium-polymer battery. In some embodiments, the energy storage device 130 is a capacitor, fuel cell, or other energy storage device. Alternatively, in some embodiments, power is provided by a hardwired connection from the drone. The drone may be powered by any number of different energy sources known in the art. In some embodiments, power is provided by a solar cell (e.g., a component that converts electromagnetic waves to electricity), a radioactive source, etc.

The optional GPS module 165 provides positional and velocity information for the node 100. A typical GPS module is the Adafruit® Ultimate GPS Breakout which can be purchased from Adafruit® Inc., is a module which is based on the MTK® 3339 chipset from MediaTek® Inc, a high-quality GPS module can do up to 10 location updates a second. In some embodiments, the GPS module 165 provides positional and velocity information for the node 100 if the positional and velocity information cannot be obtained by other means.

In some embodiments, the optional camera 170 is a color camera or a black and white camera, such as the Sony® IMX219 Color CMOS 8-megapixel. In some embodiments, the optional camera 170 detects a defined, limited range of frequencies of the electromagnetic spectrum, such as infra-red, visible, and/or ultraviolet radiation. In some embodiments, the optional camera 170 is used to record a snapshot or video of the object to be captured. In some embodiments, the optional camera 170 includes human vision capabilities such as the ability to identify and/or count objects. For example, in some embodiments, the camera 170 identifies a bird instead of a plane as an object to be captured. In some embodiments, the optional camera 170 is used for triangulation. Likewise, in some embodiments, the optional sensor 180 and/or optional microphone 190 is/are used for triangulation.

In some embodiments, the optional sensor 180 is a light sensor, inductance sensor, temperature sensor, wind sensor, biological/nuclear materials sensor, or any other kind of sensor. In some embodiments, the optional sensor 180 comprises more than one sensor or an array of sensors.

The sensing antenna 150 and network antenna 160 are antennae designed to transmit and receive signals (e.g., electromagnetic radiation). The sensing antenna 150 and network antenna 160 can be internal, integrated, external, omnidirectional or directional (e.g. “unidirectional”). The network antenna 160 is designed to connect the node 100 to a network that may include other nodes on drones in a drone swarm, other drones in the drone swarm, and a central coordinating station. An example of a network antenna 160 could be the 100 mm long 2.4 GHz Mini Flexible WiFi Antenna with uFL Connector from Adafruit® Inc. The antenna has approximately 4DBi gain and works well on the 2.4-2.5 GHz wireless frequencies. An example of the sensing antenna 150 could be the 700 MHz-2.5 GHz OmniLOG 90200® from Aaronia AG. The technology is not limited in the type of network or communications that transmits information among components of the system (e.g., between nodes, drones, and central coordinating station). One type of network/protocol is the ZigBee IEEE 802.15.4 specification protocol. The network may be implemented such that the network antenna 160 is coupled to a ZigBee communications module (not shown). In some embodiments, the network communication occurs using an external network comprising ZigBee routers that move data and control messages through the network using a hierarchical routing strategy. In some embodiments of a network configuration, a node may operate as a coordinator, a router, or an end point sensing device. In embodiments of the drone swarm network, coordinators collect network data packets from other nodes. The coordinators send the network data packets to a central coordinating station (not shown) (e.g., over a network) directly where each node is assigned its own IP (internet protocol) based connectivity or via a cellular packet-based modem, which provides the coordinator node with IP based network connectivity over a point-to-point (PPP) cellular link. Routers transmit network data packets from other nodes in the drone swarm network. End-points only send network data packets to other nodes.

However, the technology is not limited in the network communications protocols, systems, or standards used. Accordingly, embodiments provide that multiple antennae, other antennae, or other communications schemes can be employed. For example, in some embodiments the technology comprises a Bluetooth®, cellular, or satellite transmitter or receiver. Additionally, in some embodiments the technology comprises a wired network or communications link, (e.g., an Ethernet module) from the node 100 to the drone (not pictured).

In some embodiments, the node 100 includes hardware (e.g., network antenna 160) and/or software configured to connect the node 100 to various networks such as a mobile ad hoc network or an internet-based mobile ad-hoc network. A mobile ad-hoc network (MANET) is sometimes called a mobile mesh network. In some embodiments, the MANET is a self-configuring network of mobile devices connected by wireless links. Internet-based mobile ad hoc networks (iMANET) are MANETs that configure themselves over internet connections, for example, using a cellular network internet connection. Thus, various embodiments provide that the node 100 is part of various network configurations. In one illustrative embodiment, the node 100 collects information about other devices, objects, etc. that are networked with the node 100.

In some embodiments, the node 100 includes an embedded system architecture including a custom embedded hardware design coupled with firmware. For example, the node 100 detects the strength and/or frequency of emitted or reflected radiation from the remote object and with multiple measurements can measure how that strength and/or frequency changes with time. The node 100 can then use multiple strength and/or frequency measurements to determine the speed and direction of the remote object. Alternatively, the node 100 can collect signal strength and/or frequency data via the sensing antenna 150 and can provide that data to a central coordinating station information for further processing.

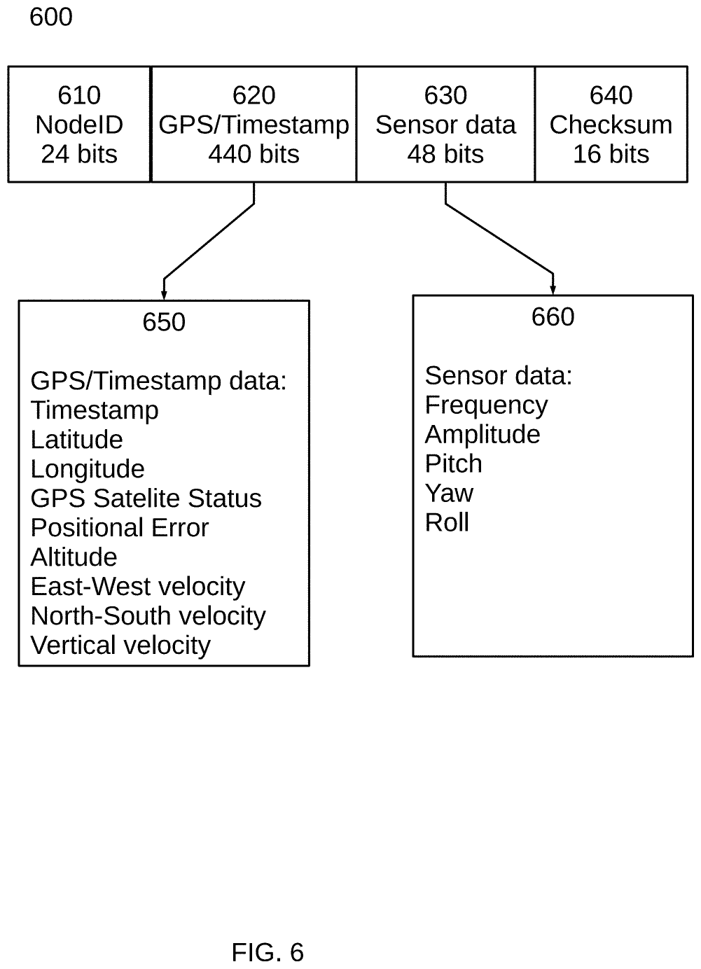

In some embodiments, after discovering a detected frequency, the node 100 produces output to be transmitted over the network. Output produced may include a node stamp, associated time stamp, GPS direction, position, and/or velocity stamp as will be documented later in the detailed description of FIG. 6. The output is transmitted using the network antenna 160. In some embodiments, the drone swarm or a central coordinating station uses multiple Doppler shift detections with the additional information to determine the speed and location of a remote sensed object.

In addition to frequency detection, in some embodiments the node 100 detects a signal strength of a signal associated with that frequency. In some embodiments, the drone swarm or a central coordinating station uses multiple signal strength measurements to determine the location of a remote sensed object.

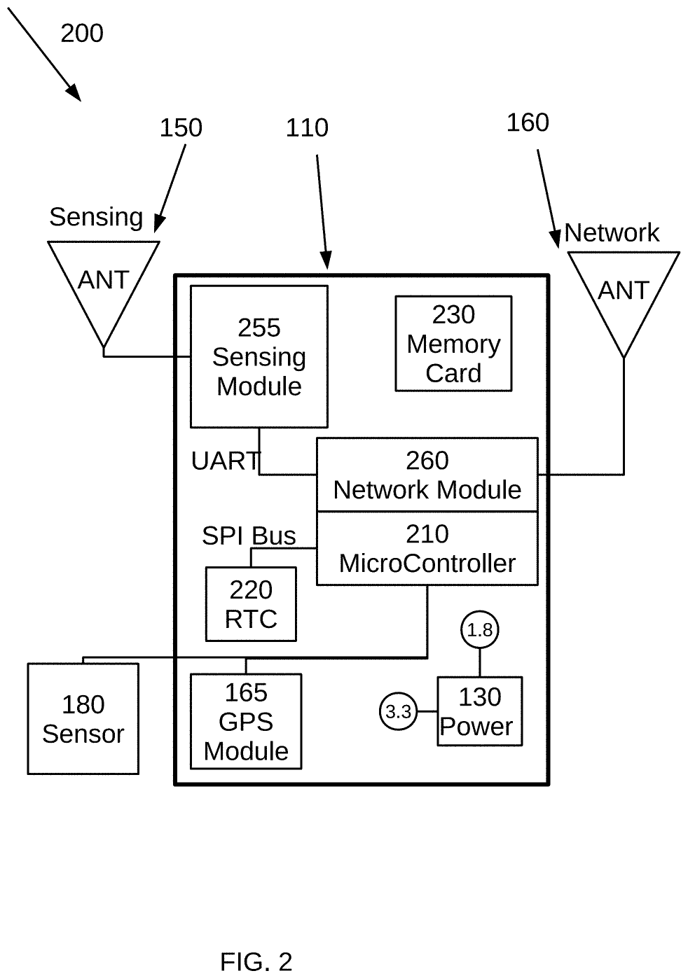

Various implementations of the node 100 are provided and contemplated by the disclosure. At its simplest, a node 100 needs to be able to sense and record what it has sensed, the time of sensing, and either its GPS location/velocity or an identification specifying a drone to which it is attached which also reports the drone's GPS location/velocity (specific embodiments not shown). For example, some embodiments comprise nodes providing a subset of features. For example, in some embodiments a system described herein comprises a network relay for the other nodes in the drone swarm to communicate through it with a reduced set of features, e.g., in some embodiments the node is mounted to a drone in a drone swarm instead of being incorporated into the body of the drone. In some embodiments having such a configuration, the GPS position is read from the drone on which the node is attached. In some embodiments, the node can be as simple as a ZigBee radio and a sensing antenna. Accordingly, the 8-bit microcontroller (used to house the ZigBee stack) that is built into the ZigBee radio can be used as a microcontroller 210 of a node 200 which then can utilize a smaller energy storage device 130 (see FIG. 2). Additionally, the size and cost of the node could be reduced to the size of a pack of gum (e.g., less than 5 cm (e.g., less than 5, 4, 3, 2, or 1 cm) in each linear dimension).

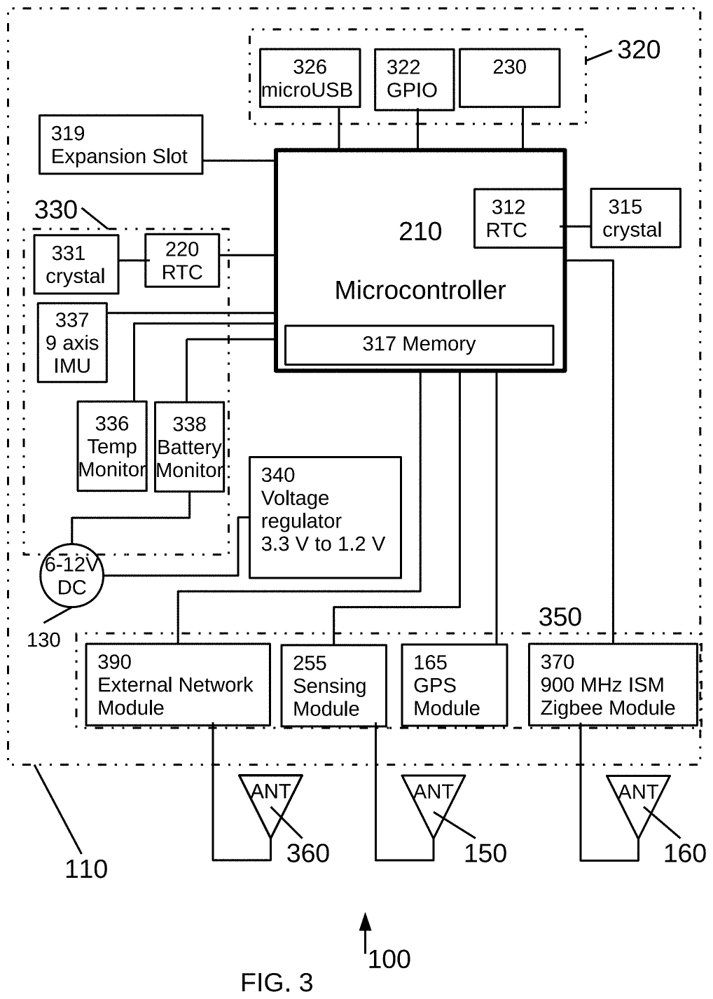

Referring to FIG. 2, a diagram of a simplified node 200 in accordance with a representative embodiment is shown. In some embodiments, the simplified node 200 is used as a network relay for the other nodes in the drone swarm to communicate through it. The node 200 includes a microcontroller 210, a real-time clock 220, memory card 230, an energy storage device 130, a sensing module 255, a GPS module 165, a sensing antenna 150, a network module 260, and a network antenna 160. In some embodiments, the simplified node 200 optionally includes a sensor 180. In some embodiments, the microcontroller 210, real time clock 220, memory card 230, energy storage device 130, sensing module 255, network module 260, and network antenna 160 are contained in a protective enclosure 110. More details about the network module 260 follow later in detailed description of FIG. 3 as 390 and 370.

In some embodiments, the microcontroller 210, real-time clock 220, memory card 160, energy storage device 130, sensing module 255, sensing antenna 150, network module 260, and network antenna 160 are integrated onto a single printed circuit board including, e.g., processors, memory, flash memory, transmitters, receivers, controllers, integrated antennae, and slots. In some embodiments, the slots are used to add upgrade modules or other features such as detectors, machine vision processors, displays (e.g., LCD screens), and/or speakers. The simplified node 200 can have various degrees of integration. For example, in some embodiments, the microcontroller 210 and network module 260 are integrated into the same integrated circuit.

The energy storage device 130 can be a battery, for example a 9 V lithium ion battery. In some embodiments, the energy storage device 130 includes a power supply controller that divides the voltage, for example, to 1.8 V and 3.3 V. The simplified node 200 may be advantageous because with fewer and simpler features it allows a lower power implementation of the technology described herein.

In some embodiments a sensor 180 is included on the node 200. The sensor 180 may be a camera, a microphone, a specialized sensor or detector, etc. Likewise, in some embodiments the node 200 may be tailored for a particular implementation of a drone swarm. In some embodiments the sensor 180 includes the ability to produce a signal that is reflected off of a remote object that does not normally emit in a frequency that the sensor 180 can easily detect, for example LIDAR where an infrared light is emitted and the sensor 180 detects reflected infrared light.

FIG. 3 provides a functional diagram of an embodiment of node 200 illustrated in FIG. 2. The node 200 includes a microcontroller 210, configuration/user interfaces 320, monitoring interfaces 330, a power supply interface 340 and sensing, data communications and transport interfaces 350. In this functional diagram of the node 100 the representative embodiment is attached to a regular drone via a Velcro® strap that loops about both drone and node. Alternatively, the drone and node could be integrated into one system. As discussed above, the microcontroller 210 can have various levels of integration.

In this example, an energy storage device 130 is integrated into the printed circuit board of the microcontroller 210. The energy storage device 130 can be a battery or power supply with capacities between 9 and 12 Volts. The energy power supply interface 340 can be, for example, a switching power supply that converts the voltage of the power supply 130 to lower voltages for the components of the microcontroller 210. For example, the energy power supply 340 can produce a 1.8V and 3.3 V source to supply power to the microcontroller 210.

The microcontroller 210 is a processor that controls the node 200. The microcontroller 210 includes a computer-readable medium such as memory 317 that contains machine-readable instructions for operating the node 200. Additionally, or alternatively, memory 317 can be distinct from the microcontroller 210. The microcontroller 210 has an internal clock (RTC) 312 and can be clocked by an oscillating crystal 315. The microcontroller 210 is also connected to one or more expansion slots 319. The expansion slot(s) 319 can be used to add additional capabilities to node 200, for example connecting to a board designed for motor(s) control, a microphone(s) or auxiliary processing module can be added as discussed above.

The microcontroller 210 can be, for example, an ARM® 32-bit Cortex®-M3 CPU available from various manufacturers including specifically the STM32F207VC from STMicroelectronics® company of Geneva, Switzerland.

The ARM® 32-bit Cortex®-M3 STM32F20x family is based on the high-performance ARM® Cortex®-M3 32-bit RISC core operating at a frequency of up to 120 MHz. The ARM® 32-bit Cortex®-M3 STM32F20x family incorporates high-speed embedded memories (Flash memory up to 1 Mbyte, up to 128 Kbytes of system SRAM), up to 4 Kbytes of backup SRAM, and an extensive range of enhanced I/Os and peripherals connected to two APB buses, three AHB buses and a 32-bit multi-AHB bus matrix. The chip family has three 12-bit ADCs, two DACs, a low-power RTC, twelve general-purpose 16-bit timers including two PWM timers for motor control, two general-purpose 32-bit timers a true number random generator (RNG). They also feature standard and advanced communication interfaces. Peripherals include an SDIO, an enhanced flexible static memory control (FSMC) interface (for devices offered in packages of 100 pins and more), and a camera interface.

The microcontroller 210 interfaces with three subsystems: configuration/user interfaces 320, internal monitoring/sensing interfaces 330, and sensing, data communications and transport interfaces 350.

The configuration/user interfaces 320 include an input/output interface 322, a memory card interface 230 and a universal serial bus (USB) 326. The input/output interface 322 can be any kind of communication port. For example, the input/output interface 322 can be a touch screen digital interface for configuring the device, a digital or analog input which is coupled to a sensor, or an interface to an auxiliary input/output module.

The memory card interface 230 includes a memory card such as a MicroSD-type flash memory card. The memory card interface 230 controls communications between the microcontroller 210 and a memory card. The memory card interface 230 can be used for storing data such as operating system configuration, detection parameters, instructions for operating the node 200 or storing data for analysis. For example, a MicroSD flash memory card can be used to store detected frequency data or higher resolution images taken of an object to be captured that can be retrieved later for analysis. A user can retrieve data from the node 200 by removing and reading the memory card. Similarly, a user can update machine-readable instructions for operating the node 100 by replacing or updating the memory card.

The USB port 326 can also be used to communicate with the microcontroller 210. The node 200 can be configured and serviced via the USB port 326. The USB port 326 can also be used to attach peripheral devices and sensors such as temperature sensors, etc. as discussed above.

The monitoring interfaces 330 include a real-time clock (RTC) 220, a temperature monitor 336, an energy source monitor 338, and a nine-access internal measurement sensor 337. The RTC 220 includes a crystal 331. The crystal 331 is, for example, an independent local 32.768 kHz crystal oscillator. An example of a nine-access internal measurement sensor 337 is the MPU-9250 Nine-Axis (Gyro+Accelerometer+Compass) MEMS MotionTracking® Device (TDK® InvenSense®, San Jose, Calif.). Time and date data used by the microcontroller 210 are cross-checked by the RTC 220 which is clocked from the crystal 331 to reduce potential clock or timing integrity problems. Software on the microcontroller 210 also provides the ability to synchronize the time and date with a remote network time-date server.

The temperature monitor 336 monitors the internal temperature of the node 100. The temperature monitor 336 includes a temperature sensor or sensors. Data from the temperature monitor 336 are passed to the microcontroller 210 using, for example, a serial peripheral interface bus.

The energy source monitor 338 can be, for example, a battery monitor. The energy source monitor 338, monitors energy storage device 130, for instance, a battery. The energy source monitor 338 can be implemented as an 8-bit analog to digital converter built into the microcontroller 210. The battery health data for the node can be communicated to a drone or to a central coordinating station for analysis and allow for low-energy warnings to be sent back to a central coordinating station.

The sensing, data communication and transport interfaces 350, include an external networking module 390 for connecting to a central coordinating station, a sensing module 255, a swarm network module 370 and a GPS module 165 The external network module 390 transmits and receives data from the microcontroller 210 via a network antenna 360. The external network module 390 can be an 802.11 b/g/n wireless module. The wireless module 390 enables communication between the node of a drone swarm and a central coordinating station or with intra-drone communications. The external network module 390 can also be used to update the machine-readable instructions for operating the node of a drone swarm 100. For example, an over-the-air protocol can be used to reflash the software. The network antenna 360 can be internal, integrated, external, omnidirectional or directional (e.g. “unidirectional”). The external network module could also be a cellular network module or any other convenient method for networking the node of a drone swarm 100 to a central coordinating station.

The sensing module 255 primarily receives but can also transmit data from the microcontroller 210 via a sensing antenna 150. The sensing module 255 can be, for example, an Analog Devices® AD9364 Integrated RF Transceiver with software tunable frequency bands from 70 MHz to 6 GHz. available from Mouser Electronics® of Mansfield, Tex., USA. The AD934 contains a software programmable highly integrated radio frequency (RF) transceiver. The device combines an RF front end with a flexible mixed-signal baseband section and integrated frequency synthesizers. The transmitter uses a direct conversion architecture that achieves high modulation accuracy with ultra-low noise. The on-board transmit (Tx) power monitor can be used as a power detector, enabling highly accurate power measurements. The fully integrated phase-locked loops (PLLs) provide low power fractional-N frequency synthesis for all Rx and Tx channels. The core of the AD9364 can be powered directly from a 1.3 V regulator. The IC is controlled via a standard 4-wire serial port and four real-time input control pins. The sensing module 255 returns frequencies detected in real time to the microcontroller 210 to be analyzed in real time. For example, as a remote emitting or reflecting object passes the node 200, the sensing module 255 can detect the frequency and amplitude of the RF signal and return that data to the microcontroller 210. The microcontroller combines that information with the signals from the GPS and the IMU and transmits that information and the drone swarm ID to a central coordinating station via the external network module 390. In this embodiment the sensing module detects RF signals, but could also be any or multiple sensing devices including LIDAR, SONAR, video cameras, or any other convenient method for sensing remote objects.

A swarm network module 370 transmits and receives data from the microcontroller 210 via a network antenna 165. The network module 370 allows the node 200 to form a network with other nodes of a drone swarm. The network can be, for instance, a mesh network. Alternatively, other network connections can be used. In one example, the network module 370 is a ZigBee (IEEE 802.15.4) transponder operating on the 900 MHz Industrial-Scientific-Medical (ISM) band. ZigBee is a low cost, low power, wireless mesh networking standard. The low cost allows the technology to be widely deployed in wireless control and monitoring applications, the low power usage allows longer life with smaller batteries, and the mesh networking provides high reliability and larger range.

Alternatively, other networking schemes and protocols can be used. Hence the node 200 can pass data to and from any other node of a drone swarm. For example, in a case where only a few of the drones in the swarm are equipped with an active sensing module 255, other nodes can pass their data through the network to the central coordinating station. Advantageously, the number of nodes requiring expensive types of sensing modules or an expensive, cellular external network module is substantially reduced.

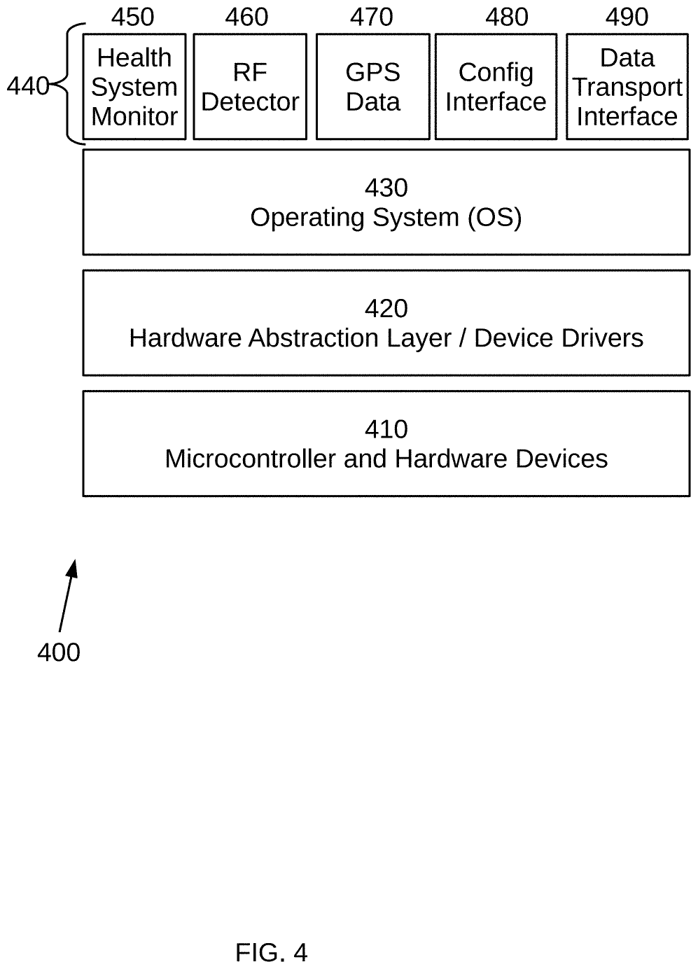

In some embodiments, the basic functions of a node are executed by firmware. Referring to FIG. 4, a diagram of the architecture for the firmware stored in memory 317 of microcontroller 210 in accordance with a representative embodiment is shown. The architecture 400 includes a hardware layer 410, a hardware abstraction layer 420, a real-time operating system (RTOS) layer 430, and an application layer 440. The hardware layer 410 represents the physical implementation of the node of a drone swarm as discussed above. The RTOS layer 430 consumes between 32 and 64 kiB of flash memory and 32 kiB of runtime memory. A hardware abstraction layer 420 is between the hardware layer 410 and the RTOS layer 430 that allows the RTOS to communicate with the hardware using device drivers.

In some embodiments, the application layer 440 comprises the following application components: a system health monitor 450, an RF Detector 460, a GPS data logger 470, a configuration interface 480, and/or a data transport interface 490. The system health monitor 450 monitors the health of the system and signals an alert when the system is not operating well, for instance, when the battery is providing a decreased voltage, insufficient voltage, or when the system is overheating. The RF detector 460 interacts with the driver (e.g., in the hardware abstraction layer 420) for the sensing module 255 and detects the frequency and signal strength of a remote object such as a drone to be captured. The GPS data logger 470 records position and velocity information and communicates the position and velocity information with an associated time stamp. The configuration interface 480 handles the user configuration of dialogs that occur over the driver (e.g., in the hardware abstraction layer 430) that handles the universal serial bus and the serial port. The data transport interface 490 is responsible for handling any network modules such as the ZigBee module or an Ethernet module if one is added.

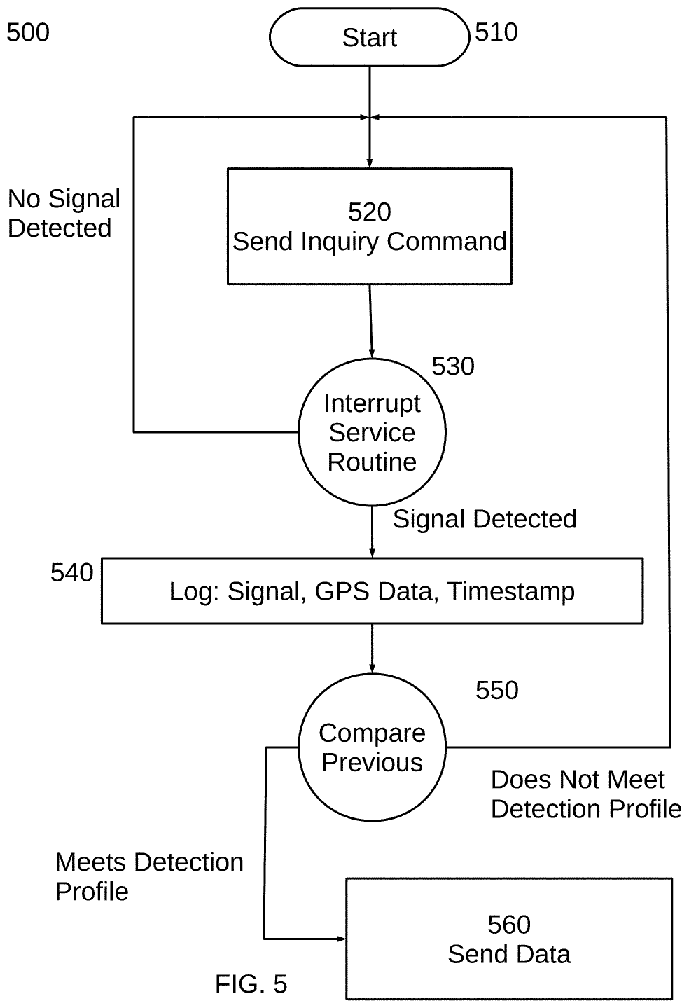

Referring to FIG. 5, a flowchart of the operations 500 performed on the microcontroller 210 through firmware 400 in accordance with a representative embodiment is shown. Embodiments provide that additional, fewer, or different operations may be performed. At step 510, the flowchart of operations 500 initializes and begins the process of looking for suitable signals. The signal inquiry command operation 520, sends an inquiry to the RF detector 460 via the device driver which is part of the hardware abstraction layer.

The RF detector 460 can report signals on a set periodic basis (every 2 seconds for example) or may be configured to continuously look for signals provided resources are available. The inquiry command 520 orders the RF detector 460 (see FIG. 4) to report frequencies and/or magnitudes within the range of the RF detector's operational capacities.

If the RF Detector 460 (see FIG. 4) had not detected a signal the process will return to step 520 and repeat. Step 530 can be controlled by for example, an interrupt service routine operation running on a real-time operating system.

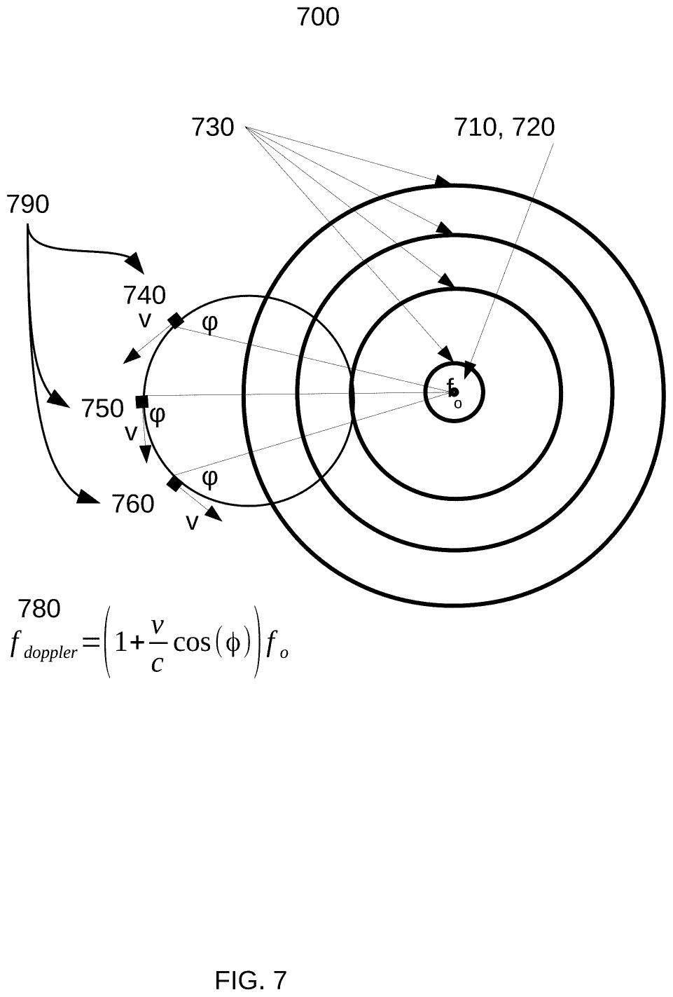

If the RF Detector 460 (see FIG. 4) has detected a signal, the process moves to step 540 where the RF Detector 460 (see FIG. 4) provides the microcontroller 210 with data from the detected signal. The microcontroller 210 logs the signal data. The microcontroller 210 at step 550 looks at any previously logged signals (step 540) and the most recent logged signal (step 540) to see if suitable signals are detected. In some embodiments, the detection of suitable signals comprises comparing to a detection profile, e.g., recording and identifying a rise and/or fall in a signal magnitude consistent with movement or a shift in frequency consistent with a Doppler shift as detailed later in FIG. 7.

If at step 550 the comparison of current and previous signals does not find suitable signals, the flowchart of operations 500 returns to step 520. However, if a suitable signal is found, the microcontroller 210 assembles and transmits over the network the node signal detection packet 600 (see FIG. 6) based on the data provided from the application layer 440 (see FIG. 4). More details regarding the node signal detection packet 600 are provided in the description of FIG. 6. In some embodiments the node signal detection packet 600 is not immediately transmitted over the network, but is stored in local flash storage for later transmittal. The format of the data to be sent is expanded on in more detail in FIG. 6.

Referring to FIG. 6, a diagram of a node signal detection packet 600 in accordance with a representative embodiment is shown. The microcontroller 210 of the node 200 assembles the node signal detection packet 600. Microcontroller 210 may transmit the node signal detection packet 600 to other nodes, to a central coordinating station, or may store it in flash memory or any other type of memory available for storage. The embodiment of the node signal detection packet 600 shown in FIG. 6 includes a node id 610, a GPS/timestamp 620, sensor data 630, and a checksum 640. However, other embodiments may include any combination of the elements listed above and may include more than one of each type of element. Further, the node signal detection packet 600 is not limited in its length. The bit numbers listed in FIG. 6 are merely exemplary. Accordingly, the node signal detection packet 600 can be any length (e.g., 1, 2, 4, 8, 16, 32, 64, 128, or more bytes). The node id 610 is the MAC address (e.g., 24-bit MAC address) of the node that detected the signal from the remote object. The GPS/timestamp 620 includes data regarding the location of the drone that detected the remote object and/or data regarding the time the remote object was detected. In some embodiments, the GPS/timestamp 620 may include the date, year, time, latitude, longitude, position status, position error, altitude, East-West velocity, North-South velocity, and/or vertical direction velocity 650. The sensor data 630 includes data regarding the signal detected from the remote object. In some embodiments, sensor data 630 includes data such as frequency and amplitude of the detected signal from an antenna 150 as well as pitch, yaw, and roll of the drone from the internal measurement sensor 337. In some embodiments, the sensor data 630 comprises frequency and amplitude from an omnidirectional antenna 150; frequency, amplitude, pitch, yaw, and roll from the internal measurement sensor 337; intensity from a unidirectional microphone 190; spot locational information from a camera 170; and/or data from any sensor that is capable of detecting a remote object 180. The checksum 640 may be a numerical check of the node signal detection packet 600. A checksum 640 allows a reader of digital data (e.g. another node or a central coordinating station) to check to see if data has been read correctly. A checksum 640 is common in the transmission of digital data and will be obvious to those skilled in the art. An example of creating a checksum is creating a 16-bit binary representation of the data portion of a node signal detection packet (610, 620, 630), the sum of which is the checksum 640.

In some embodiments, the node signal detection packet 600 optionally includes other fields such as data type, extension fields, destination address, and control flags. In some embodiments, the node signal detection packet 600 is encrypted and includes features such as forward error correction.

Referring to FIG. 7, a drawing of a node signal detection analysis 700 in accordance with a representative embodiment is shown. In some embodiments, as shown in the drawing, a node uses a Doppler frequency shift equation 780 across a sequence of samples to determine if the detected sample logged in step 540 matches and/or is similar to a signal detection profile (see FIG. 5) based on a Doppler shift effect. In the drawing of a node signal detection analysis 700, a remote object 710 emits a signal at a frequency fₒ 720. The frequency fₒ 720 (over time?) is represented by concentric circles 730. It should be understood that the frequency fₒ 720 may be emitted by remote object 710 or may be a signal reflected off of remote object 710. In the embodiment depicted, a sensing drone 790 orbits in a geometric pattern at a constant velocity detecting signals. As the sensing drone 790 orbits, it makes sample detections at detection sample points 740, 750, and 760. The instantaneous velocity of the node at each of the detection sample points 740, 750, and 760 is depicted in FIG. 7 as a directional magnitude arrow with the v symbol next each of the detection sample points 740, 750, and 760. As is shown in FIG. 7, when the sensing drone 790 is at detection sample point 740, the sensing drone 790 has a component of motion directly away from the remote object 710 and so detects a frequency lower than the emitting frequency fₒ 720 as given the by Doppler frequency shift equation 780:

$${f}_{doppler} = ( 1 + \frac{v}{c} cos ( φ ) ) {f}_{o}$$

where c is the speed of light and v is the velocity of the node relative to the remote object 710 at the time of measurement. When sensing drone 790 is at detection sample point 750, sensing drone 790 is moving perpendicular (φ=90 degrees) to the remote object 710 and so detects a frequency equal to frequency fₒ 720. When sensing drone 790 is at detection sample point 760, sensing drone 790 has a component of motion directly towards the remote object 710 and so detects a frequency higher than frequency fₒ 720.

In the embodiment depicted in FIG. 7, the sensing drone 790 moves at a constant angular velocity in a circle. However, the technology is not limited to such movement and the technology encompasses movement in other patterns and shapes at variable or constant velocity and/or angular momentum. Further while FIG. 7 depicts a singular drone, this is merely for clarity and descriptive purposes. Exemplary embodiments will include a plurality of sensing drones performing detection of remote objects simultaneously.

### Drone Swarm Detection and Capture System

In accordance with a representative embodiment, a drone swarm detection and capture system comprises a plurality of sensing drones equipped with nodes (as described above). The sensing drones monitor remote objects and triangulate the location of the remote objects, e.g., by simultaneously measuring detected signals from those remote objects and combining those signals to triangulate and capture a remote object in real time.

In some embodiments, a central coordinating station is part of the system. In these embodiments, the central coordinating system gathers the data transmitted from individual sensing drones (as described in FIGS. 4-6). In some embodiments, the data transmitted is node signal detection packet 600 (see FIG. 6). By collecting and processing sensor information from sensing drones at two or more different locations the central coordinating station can determine the location, speed, and direction of the remote object.

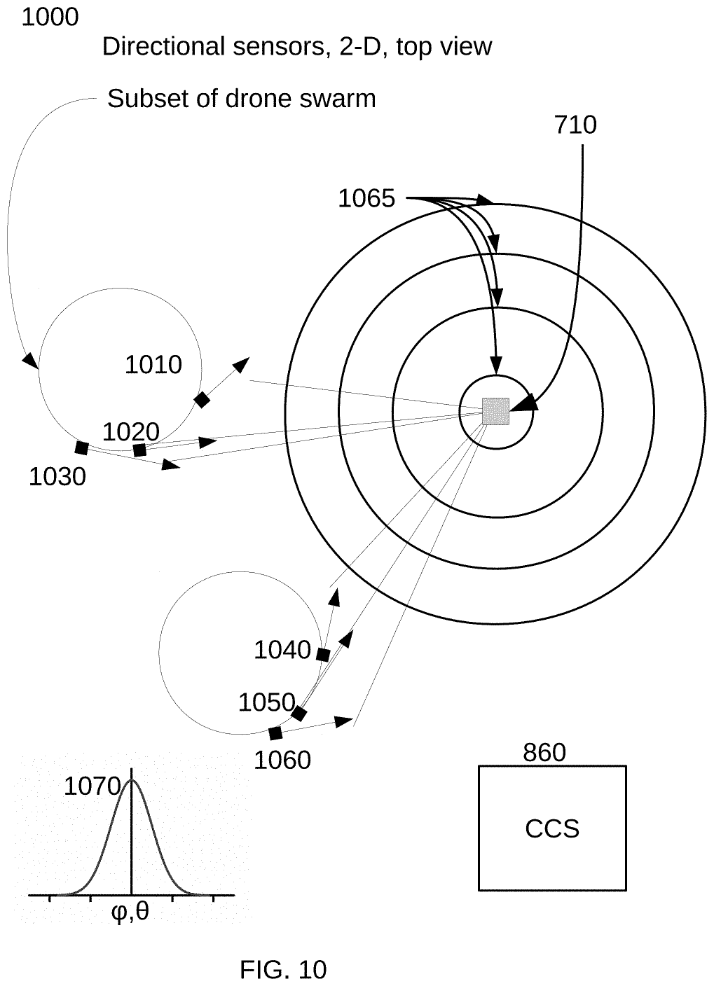

The technology is not limited in the configuration in which the drone swarm performs detection. For example, in some embodiments, the drone swarm performs detection using Doppler shift detection (as illustrated in FIG. 7). In other embodiments, the drone swarm performs detection using magnitude detection (as illustrated in FIG. 10). The type of detection used by the drone swarm may require different arrangements of drones in the drone swarm. For example, detection using magnitude detection with a unidirectional antenna 150 requires drones to sweep the direction of the unidirectional antenna across the area to scan which can be achieved with just a rotation of a drone or small radius orbit while omnidirectional antenna 150 cannot sweep in such a manner and thus require the drones to orbit with a larger radius. Embodiments provide that various combinations of the two approaches are possible. Alternatively, other sensing configurations are used in various embodiments.

In some embodiments, a remote object is identified by a user and information describing the remote object (e.g., spatial coordinates, GPS information, an image (e.g., a photograph), a sound, a sound profile, a heat profile, etc.) is provided by the user to the drone swarm, a system as described herein, a central coordinating station, etc. In some embodiments, a signal produced by the user (e.g., an electromagnetic wave) is directed toward the remote object by the user and is reflected from the remote object for sensing by a node as described herein.

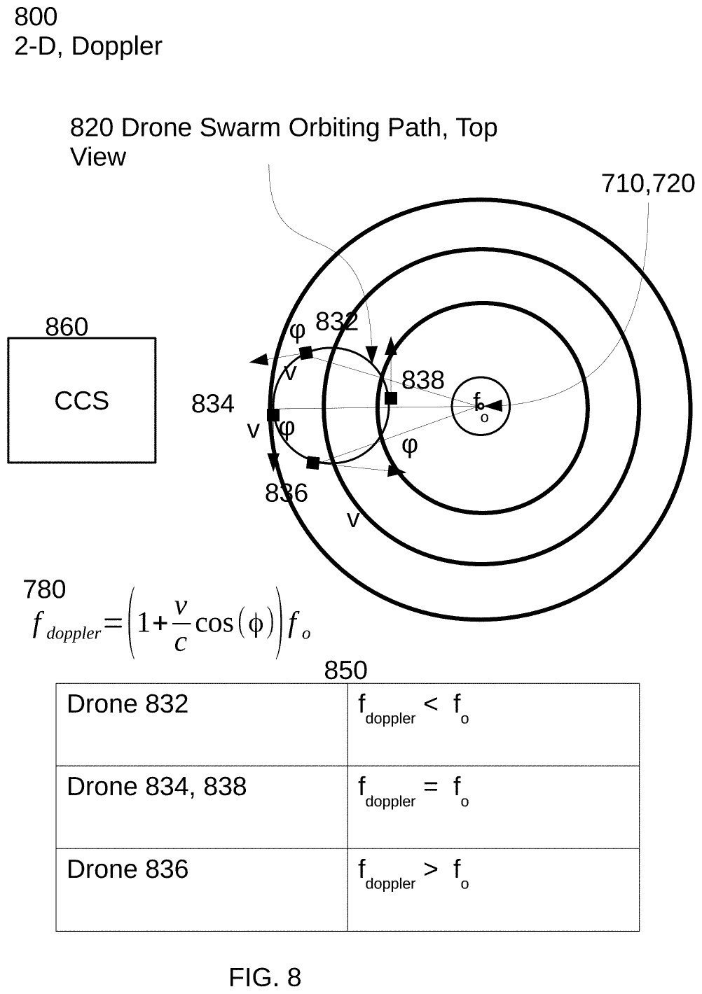

An embodiment of a drone swarm Doppler sensing configuration is shown in FIG. 8, which is a 2-dimensional top view of a drone swarm. A comparison of FIG. 7 and FIG. 8 demonstrates some characteristics of the drone swarm Doppler sensing configuration. In particular, FIG. 7 shows one sensing drone's Doppler shift measurements as the sensing drone 790 moves relative to the remote object 710. FIG. 8 shows a drone swarm Doppler sensing configuration in which a plurality of (or all) sensing drones make the same or similar Doppler shift measurements simultaneously. Referring to FIG. 8, a diagram of a drone swarm Doppler sensing configuration 800 In this embodiment the sensing drones 832, 834, 836, and 838 are equipped with nodes (such as those depicted in FIG. 3) that are networked together. The network may be WiFi, a packet-based network or any other network known in the art. In this embodiment, the frame of reference is set such that the origin is at rest relative to a remote object 710. The drone swarm (sensing drones 832, 834, 836, and 838) in the network 800 monitors an area to detect, for example, that a remote object 710 is emitting or reflecting a signal. In the example the frequency of the signal emitted or reflected from the remote object 710 is at frequency fₒ 720. A drone swarm 820 comprises a plurality of sensing drones equipped with nodes moving (e.g., rotating) in a circle. However, the technology is not limited in the pattern or shape in which the drones of the drone swarm move and, accordingly, embodiments provide that other geometric patterns are employed (e.g., oval, polygonal, elliptical, processing, three-dimensional, etc.). As shown in FIG. 8, sensing drones 832, 834, 836 and 838 are moving (e.g., rotating) in a geometric pattern. Each sensing drone in the drone swarm 820 has an angle φ between the velocity vector and a straight-line distance from each drone with node to the remote object 710. In this frame of reference, where the origin is at rest relative to the remote object 710, the Doppler shift measured by each sensing drone is given by the equation 780:

$${f}_{doppler} = ( 1 + \frac{v}{c} cos ( φ ) ) {f}_{o}$$

where c is the speed of light and v is the velocity of each sensing drone in the drone swarm 820 relative to the origin and f_{doppler} is the frequency detected by each node in the drone swarm 820. The difference here being that v in FIG. 7 was one node at multiple times and FIG. 8 shows nearly simultaneous measurements from multiple sensing drones each with its own velocity and position. The signal (e.g., frequency of the signal) detected by each drone in the drone swarm depends on the velocity of the drone relative to the remote object 710. Drones 834, 838 in the drone swarm that are moving perpendicularly to the remote object 710 will simultaneously detect no frequency shift or f_{doppler}=fₒ. Drone 836 which is moving with a velocity component toward the remote object 710 will simultaneously detect a higher frequency and drone 832 simultaneously moving away relative to the remote object will simultaneously detect a lower frequency. This difference in detected frequency occurs whether or not the remote object 710 is moving relative to the center of the drone swarm and is shown in the frequency shift table 850. In this configuration these differences plus GPS information are sent to a central coordinating station 860 that use this information to track the remote object 710. It should be understood that while the drone swarm 820 is depicted in FIG. 8 as having drones 832, 834, 836, and 838, the number of drones in the drone swarm 820 may be more or less than the four depicted. Further, it should be understood that each of the drones 832, 834, 836, and 838 may represent multiple drones.

In some embodiments, each of the nodes communicates with the central coordinating station 860 independently. In some embodiments, the central coordinating station 860 coordinates data collection and other activities amongst the nodes. For example, in some embodiments subsets of drones with nodes have been preprogrammed by a central coordinating station to move in preprogrammed patterns and so can launch without needing to communicate in real-time to a central coordinating station.

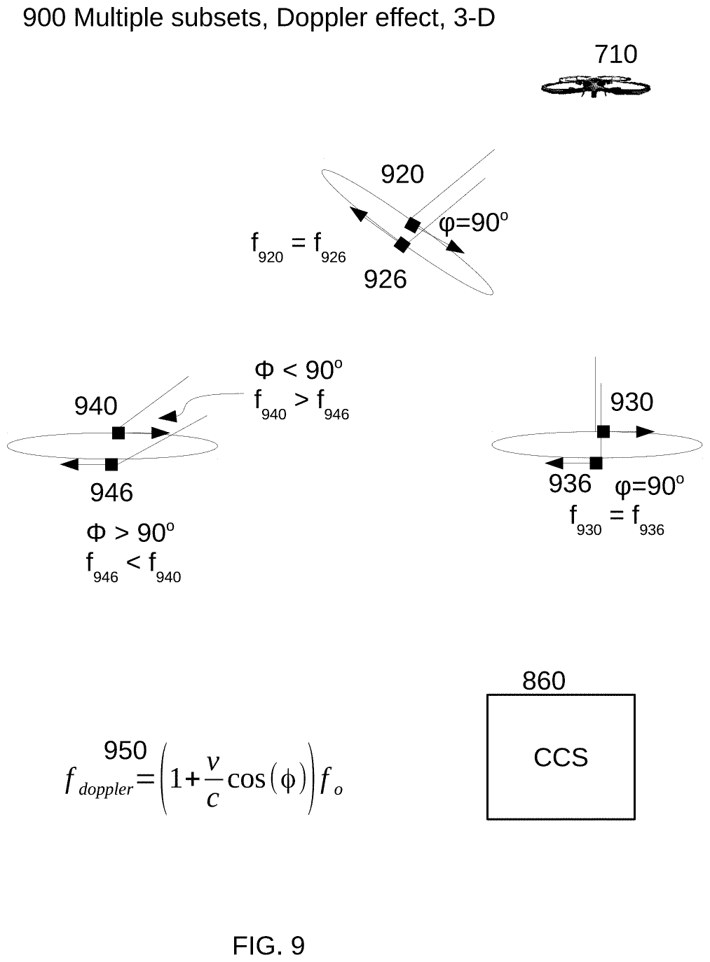

Referring to FIG. 9, a diagram of a drone swarm 900 in a network (e.g., a WiFi, packet-based network) with subsets of drones acting independently for greater accuracy in accordance with a representative embodiment is shown. In this embodiment, a remote object 710 is detected by sensing drones equipped with nodes 920, 926, 930, 936, 940, and 946. In this embodiment, each subset (920 and 926; 930 and 936; 940 and 946) of drones travels about a point. In some embodiments, more or fewer drones in the drone swarm are used; in some embodiments, more or fewer subsets are used; and, in some embodiments, subsets comprise any number of drones, e.g., 2, 3, 4, 5, 6, or more drones. In this exemplary embodiment, drones 920 and 926 are orbiting such that their angular velocity is perpendicular to the direction of the remote object 710. Drones 930 and 936 are also orbiting such that their angular velocity is perpendicular to the direction fo the remote object 710. Because the equation for the measured Doppler shift is relative to the velocity along a straight line between emitter and receiver, the subset of drones with nodes orbiting perpendicular to the remote object 920, 926 and 930, 936 have nodes that detect frequencies that are the same. This is true even if the remote object 710 is moving. Drones with nodes 940 and 946 detect a Doppler shift depending on the direction of travel as a higher frequency when a node 940 is traveling toward the remote object 710 and sensing a lower frequency when a node 946 is traveling away from the remote object 710. In some embodiments, all drones in the drone swarm 900 comprising a network and subsets acting independently for greater accuracy send their GPS encoded data independently to a central coordinating station 860. Then, the central coordinating station 860 identifies the position of remote object 710 and directs the drone swarm. Although triangulation is performed using the Doppler shift information in the exemplary embodiment described, the triangulation of the position of the remote object 710 is also performed in some embodiments with directional sensing antennae 150 that use as a sensing criteria for magnitude change instead of a Doppler shift. Alternatively, triangulation is performed in some embodiments with a microphone that senses Doppler shifts or a microphone that senses magnitude changes or a camera that senses change in size or position.

Referring to FIG. 10, a two-dimensional diagram of a drone swarm 1000 with directional sensing antennae 150 and subgroupings is shown. In the drone swarm 1000 shown in FIG. 10, the drone swarm looks for a magnitude change using subsets of drones acting independently for greater accuracy. In the drone swarm 1000, the nodes 1010, 1020, 1030, 1040, 1050, and 1060 of the drone swarm 1000 detect a signal represented as consecutive circles 1065 from a remote object 710. The remote object 710 has a signal profile 1070 that increases then decreases as a directional sensing antenna 150 attached to a node sweeps past the direction in which the remote object 710 is located. In some embodiments, all nodes and drones in the drone swarm 1000 communicate via a network (e.g., WiFi, packet-based network) and are divided into subsets acting independently for greater accuracy and send their GPS encoded data independently to a central coordinating station 860, which allows the central coordinating station to identify the positioning of remote object 710 as well as direct the drone swarm.

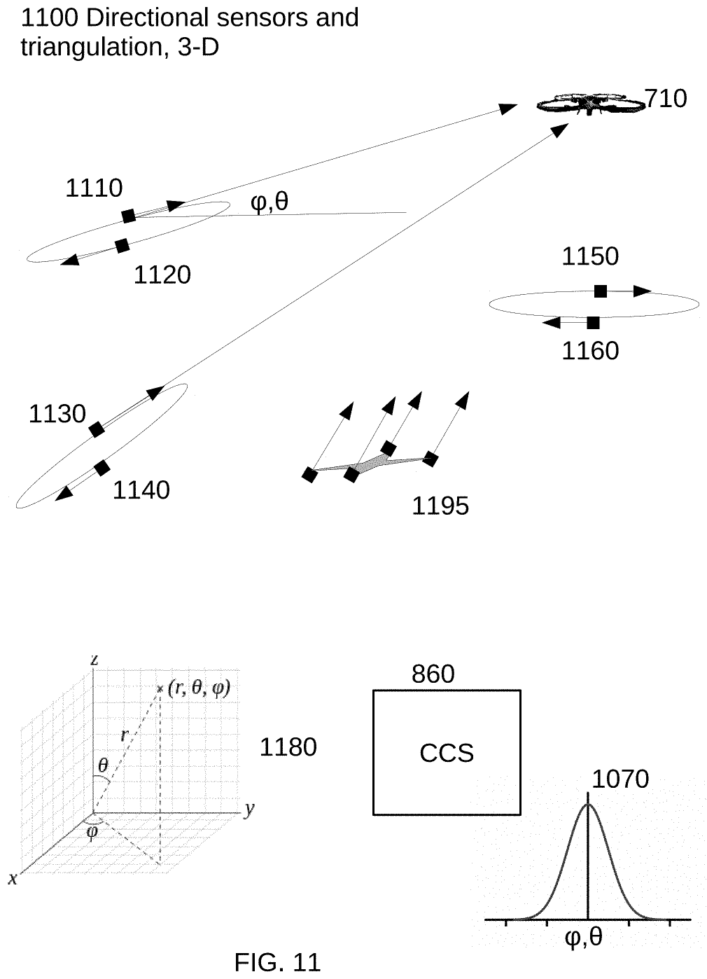

In contrast to a rotating radar array on a fixed pole, embodiments of the present technology provide that subsets of the drone swarm rotate in a full spherical three-dimensional space. Referring to FIG. 11, a three-dimensional diagram of a drone swarm 1100 with directional sensing antennae 150 to detect a magnitude change with subgroupings acting independently for greater accuracy in accordance with a representative embodiment is shown. In some embodiments, the subset of a drone swarm 1100 includes drones with nodes orbiting in different spherical planes 1110, 1120, 1130, 1140, 1150, and 1160. The technology is not limited in the number of drones in the swarm, the number of subgroupings, or the number of drones in each subgroup. Accordingly, while the diagram of FIG. 11 shows three independent drone swarm subgroups, the drone swarm comprises more or fewer in various embodiments.

In the exemplary embodiment shown in FIG. 11 for sensing a remote object 710, the technology provides three-dimensional freedom in which drone subgroups in a drone swarm 1100 comprise directional sensing antennae 150 to triangulate a remote object more quickly and with greater accuracy than a stationary sensing array could achieve. In spherical coordinates where φ is an azimuthal angle and θ is a polar angle 1180, subsets of the drone swarm are oriented in some embodiments such that sensors monitor a signal amplitude as a function of θ and φ to provide a direction for the remote object 710 as detected from each drone subset.

In some embodiments, each drone with a node communicates back to a central coordinating station 860 sending packets containing position (e.g., GPS) data to the central coordinating station 860 as described above. All drones in the network (e.g., a WiFi, packet-based network) with subgroupings acting independently for greater accuracy 1100 have nodes that send their GPS encoded data independently to a central coordinating station 860, which allows the central coordinating station to identify the positioning of the remote object 710 as well as to direct the drone swarm. Although the triangulation described above comprises use of directional RF antennae, triangulation of the position of the remote object 710 is, in some embodiments, performed with any directional sensor, e.g., a microphone or a camera that senses change in size or position. In some embodiments, the central coordinating station directs subsets 1195 of the drone swarm that are dedicated to capturing the remote object 710. The remote object 710 has a signal profile 1070 that increases then decreases as a directional sensing antenna 150 attached to a node sweeps past the direction in which the remote object 710 is located.

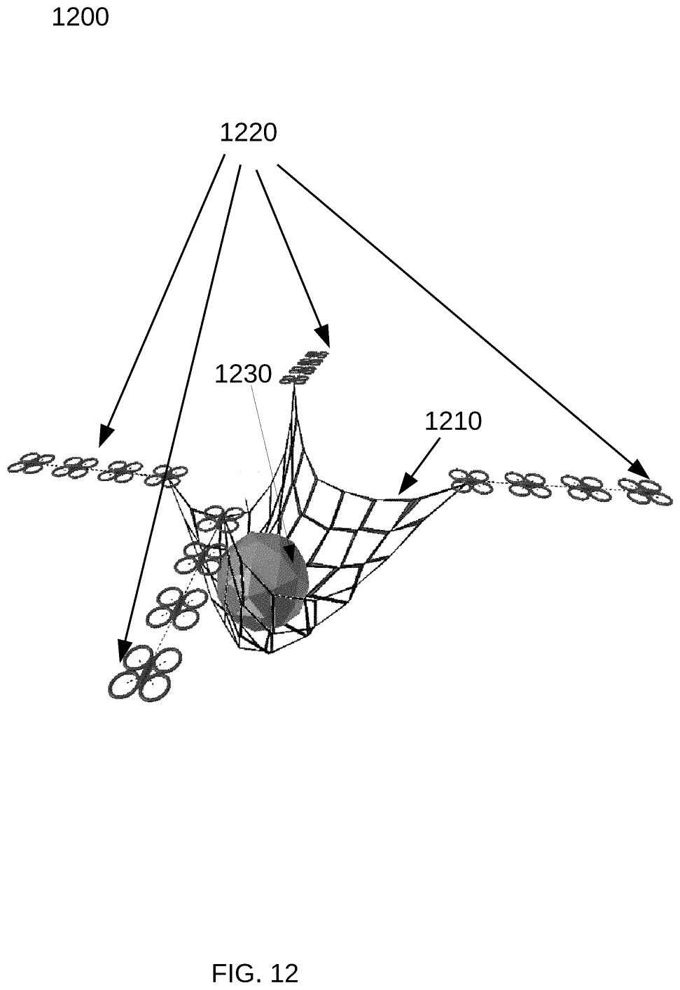

Referring to FIG. 12, a drawing of an entanglement device carried by a subset of drones in a drone swarm 1200 in accordance with a representative embodiment is shown. The entanglement device 1210 is carried by a subset of a drone swarm 1220. The technology is not limited in the number of drones that carry the entanglement device. In some embodiments, the entanglement device is carried by 1, 2, 3, 4, 5, 6, 7, 8, 9, 10, 11, 12, 13, 14, 15, 16 (see, e.g., FIG. 12), 17, 18, 19, 20, 21, 22, 23, 24 or more drones.

The dimensions of the entanglement device 1210 are known and the absolute positions of each node and/or the relative positions of each node relative to one or more other nodes are known. Accordingly, embodiments provide that the innermost nodes of the drone swam prevent the entanglement device from entangling other drones. In some embodiments, the subset 1220 of the drone swarm comprises all of the drones in the drone swarm. In some embodiments, the subset 1220 of the drone swarm comprises fewer than all of the drones in the swarm. In some embodiments, the drones of the subset 1220 of the drone swarm carrying the entanglement device are directed by independent subsets of the drone swarm that are dedicated to detection and triangulation.

In the example shown in FIG. 12 of an entanglement device carried by a drone swarm 1200, the entanglement device 1210 has captured a remote object 1230. In some embodiments, the entanglement device 1210 carried by a subset of drones in the drone swarm 1220 approaches the remote object 1230 from below. However, embodiments provide any number of entanglement strategies that are employed, e.g., including but not limited to approaching the remote object with the entanglement device from above or from the side or any angle therebetween, dropping the entanglement device 1210 onto the remote object from above, pushing on the remote object 1230 with the entanglement device 1210, e.g., from any direction, etc. The exemplary entanglement device 1210 shown in FIG. 12 is a net carried by sixteen nodes in a drone swarm 1200; however, in some embodiments the construction of the entanglement device has more or fewer connections and is carried by more or fewer drones. In some embodiments, the entanglement device comprises one or more of a bag, threads, loops, wires, tubes, fabric, or any manner of material suitable to be carried by a subset of drones in a drone swarm and able to entangle remote objects on air, land, and/or sea.

For an example of a method that includes detection and entanglement, the central coordinating system 860 directs a subset of the drone swarm to monitor an area and if a remote object is detected and an operator chooses to entangle the remote object, the central coordinating system directs a subset of the drones carrying a net to move such that the center the net is positioned at the same positional location of the remote object by coming at the object from above. It is to be understood that although a net-type implementation is described, embodiments provide that the system and method for drone swarm detection and entanglement is used with different capturing strategies. The embodiments were chosen and described to explain the principles of the invention and as practical applications of the invention to enable one skilled in the art to utilize the invention in various embodiments and with various modifications as suited to the particular use contemplated.

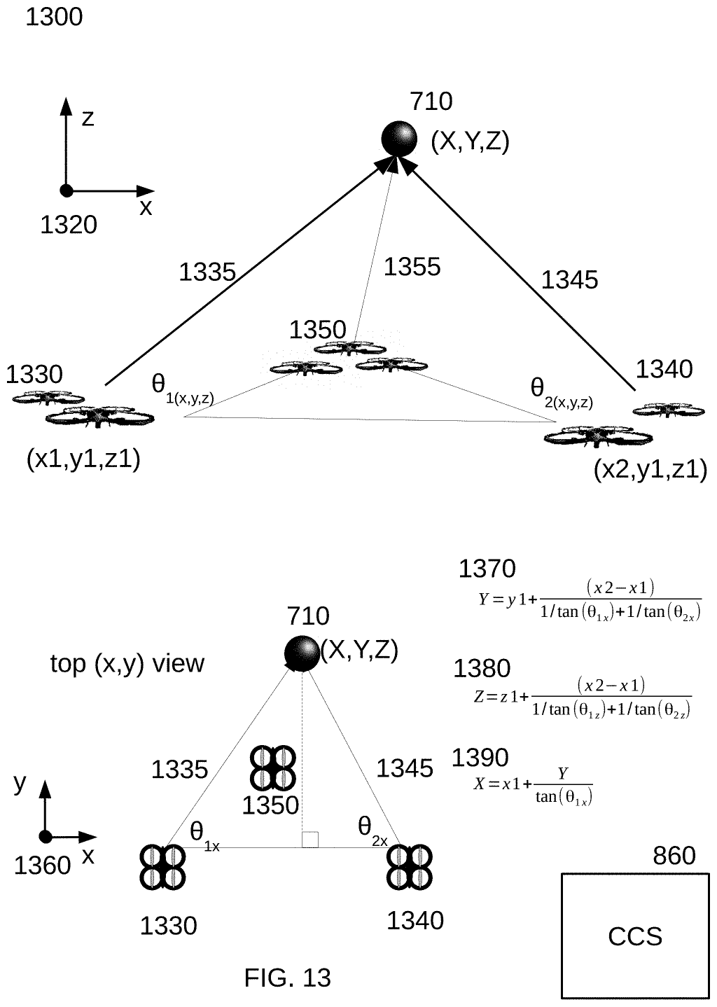

Referring to FIG. 13, a diagram of a central server processing information from nodes in a drone swarm to triangulate a remote object relative to a central coordinating station 1300 is shown. Embodiments provide triangulating the location of a remote object 710 to a general coordinate (x, y, z) system that is used to control all drones in a drone swarm. For example, in some embodiments, a view in the (side) z-x plane 1320 of a subset of the drone swarm centered at (x1, y1, z1) 1330, a subset of the drone swarm centered at (x2, y1, z1) 1340, and a subset of the drone swarm centered at (x3, y3, z3) 1350 with each subset of the drone swarm having identified a vector 1335, 1345, 1355 pointing from their respective locations to the remote object 710, which has unknown coordinate location (X, Y, Z). For illustration purposes, the coordinate origin is shown in FIG. 13 so that the drone swarm subset at (x1, y1, z1) 1330 and drone swarm subset at (x2, y1, z1) 1340 are on the same x-y plane, but the mathematics is identical for any arbitrary origin location or position of drone swarm subsets and/or remote objects. The vectors 1335, 1345, 1355 from the subset of the drone swarms 1330, 1340, and 1350 are determined by methods described above. Triangulation only requires two triangulation vectors to be known but this does not preclude more vectors being determined by additional drone swarms for increased accuracy. Accordingly, embodiments comprise determining 2, 3, 4, 5, 6, 7, 8, 9, 10, or more triangulation vectors.

Furthermore, in some embodiments the technology provides for defining θ_{X} as the angle from a projection of a vector onto the x-y plane to the x axis, θ_{y} as the angle from a projection of a vector onto the y-z plane to the y axis, and θ_{z} as the angle from a projection of a vector onto the z-x plane to the z axis. Accordingly, embodiments provide defining those angles for the first drone swarm subset 1330 as θ_{1(x,y,z)} and those angles for the second drone swarm subset 1340 as θ_{2(x,y,z)} and so on.

From the top (x-y plane) view 1360, embodiments of the technology provide calculating the Y component of the remote object 710 as:

$$Y = y 1 + \frac{( x 2 - x 1 )}{1 / tan ( {θ}_{1 x} ) + 1 / tan ( {θ}_{2 x} )} 1370$$

the Z component of the remote object 710 as:

$$Z = z 1 + \frac{( x 2 - x 1 )}{1 / tan ( {θ}_{1 z} ) + 1 / tan ( {θ}_{2 z} )} 1380 ;$$

and the X component of the remote object 710 as:

$$X = x 1 + \frac{Y}{tan ( {θ}_{1 x} )} 1390.$$

The central coordinating station 860 is sent updated packet data from a subset of nodes of the drone swarm and, in some embodiments, the central coordinating station 860 updates the triangulation information in real-time. In some embodiments, the central coordinating station 860 directs the drone swarm to continue in a pattern which allows nodes to monitor the remote object 710. In some embodiments, the central coordinating station 860 directs the subset of the drone swarm with an entanglement device to capture the remote object 710 as described above.

In some embodiments, the position and/or velocity of a remote object, a node, a drone, a subset of a drone swarm, and/or a drone swarm is described using quaternions.

Some embodiments of the technology provided herein further comprise functionalities for collecting, storing, and/or analyzing data. For example, in some embodiments the technology comprises one or more components comprising a processor, a memory, and/or a database for, e.g., storing and executing instructions, analyzing data, performing calculations using the data, transforming the data, and storing the data. Moreover, in some embodiments, one or more components comprises a processor configured to control a drone, a subset of drones, a system comprising drones, etc. In some embodiments, a processor is used to initiate and/or terminate measurement and data collection (e.g., detection and quantification of an emitted or reflected signal). In some embodiments, the technology comprises a user interface (e.g., a keyboard, buttons, dials, switches, and the like) for receiving user input that is used by a processor to provide instructions to the systems and other components of the technology described. In some embodiments, the technology further comprises a data output for transmitting data to an external destination, e.g., a computer, a display, a network, and/or an external storage medium. Some embodiments comprise a small, handheld device for use by a user to provide instructions and/or receive data or outputs from embodiments of the technology provided herein.

The foregoing description of the exemplary embodiments has been presented for purposes of illustration and of description. It is not intended to be exhaustive or to limit the invention to the precise form disclosed, and modifications and variations are possible in light of the above teachings or may be acquired from practice of the invention. For example, the described representative embodiments focused on RF detection and ZigBee networking. The present invention, however, is not limited to detecting RF emitting objects. Those skilled in the art will recognize that the device and methods of the present invention may be practiced using other connectivity and other detection means. Additionally, embodiments provide that the networking is done using other networking methods. Further, although a net-type implementation is described, embodiments provide that the system and method for drone swarm detection and entanglement is used with different capturing strategies. The embodiments were chosen and described to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

All publications and patents mentioned in the above specification are herein incorporated by reference in their entirety for all purposes. Various modifications and variations of the described compositions, methods, and uses of the technology will be apparent to those skilled in the art without departing from the scope and spirit of the technology as described. Although the technology has been described in connection with specific exemplary embodiments, it should be understood that the invention as claimed should not be unduly limited to such specific embodiments. Indeed, various modifications of the described modes for carrying out the invention that are obvious to those skilled in the art are intended to be within the scope of the following claims.

The claims defining the invention are as follows:

1. A system for locating a remote object, the system comprising:
a drone swarm, wherein the drone swarm includes a plurality of drones configured to include a network for communication throughout the system, including at least two sensing drones, wherein the sensing drones include a node configured to detect a remote object and determine the location of the remote object.

2. The system of claim 1, wherein the nodes on at least two of the sensing drones are configured to determine the location of the remote object by triangulating the position of the remote object.

3. The system of claim 1, wherein the nodes on at least two of the sensing drones are configured to cause the sensing drones to move in a geometric pattern and further wherein the nodes on the at least two sensing drones are configured to detect signals emitted from a remote object.

4. The system of claim 1, wherein the nodes on at least two of the sensing drones are configured to cause the sensing drones to move in a geometric pattern and further wherein the nodes on the at least two sensing drones are configured to detect signals reflected from a remote object.

5. The system of claim 1 wherein the nodes of at least two of the sensing drones are configured to use frequency Doppler shift detection to determine a position of the remote object.

6. The system of claim 1, wherein the nodes of at least two of the sensing drones are configured to use frequency Doppler shift detection to determine a velocity of the remote object.

7. The system of claim 1 wherein the nodes of at least two of the sensing drones are configured to use signal magnitude detection to determine a position of the remote object.

8. The system of claim 1 wherein the nodes of at least two of the sensing drones are configured to use signal magnitude detection to determine a velocity of the remote object.

9. The system of claim 1, wherein a node includes a sensor.

10. The system of claim 9, wherein the sensor includes one or more of an electromagnetic wave detector, a microphone, an optical sensor, or a camera.

11. The system of claim 1, further comprising:
an entanglement device; and
the drone swarm further includes at least two entanglement drones, wherein the entanglement drones are configured to carry the entanglement device.

12. The system of claim 11, wherein at least two of the entanglement drones carry the entanglement device.

13. The system of claim 12, wherein the at least two entanglement drones carrying the entanglement device are configured to receive data from the sensing drones of a location of the remote object.

14. The system of claim 13, wherein the at least two entanglement drones carrying the entanglement device are configured to coordinate capturing the remote object using the entanglement device.

15. The system of claim 12, further comprising a central coordinating station, wherein the central coordinating station is configured to include the network for communication throughout the system.

16. The system of claim 15, wherein the central coordinating station provides instructions to the drone swarm how to move to detect the remote object, receives data from the sensing drones in the drone swarm to calculate the location of the remote object, and provides instructions to the entanglement drones to capture the remote object.

17. The system of claim 16, wherein the drone swarm includes a subset of drones, wherein the number of drones in the subset of drones is a minimum of one drone and a maximum of one less than the total number of drones in the drone swarm.

18. The system of claim 11, wherein the entanglement device is a net.

19. A method for locating a remote object with a drone swarm, the method comprising:
providing a drone swarm, wherein the drone swarm includes a plurality of drones configured to include a network for communication, including at least two sensing drones, wherein the sensing drones include a node configured to detect a remote object and determine the location of the remote object;
directing at least two of the sensing drones to detect a signal from the remote object;
detecting, by at least two of the sensing drones, the signal from the remote object, wherein the node on the sensing drones that detect the signal from the remote object are configured to store a location data set and a signal data set at the time of detection, wherein the location data set pertains to the location of the sensing drone at the time of detection and wherein the signal data set pertains to the signal data received from the remote object at the time of detection;
transmitting the location data set and the signal data set over the network; and
determining the location of the remote object for which the signal was detected.

20. The method of claim 19, wherein the location and velocity of the remote object is determined by a triangulation of the location data set and the signal data set.

21. The method of claim 20, wherein the location data set includes a nodeID, a location of the node, a velocity of the node, and a timestamp of the node at the time of detection.

23. The method of claim 20, wherein the signal data set includes at least one of a frequency of the signal at the time of detection, an amplitude of the signal at the time of detection, or a pitch of the signal at the time of detection.

24. The method of claim 20, wherein the triangulation is determined using frequency Doppler shift detection.

25. The method of claim 20, wherein the triangulation is determined using signal magnitude detection.

26. The method of claim 20, wherein the node of at least one of the sensing drones is configured to perform the triangulation.

27. The method of claim 20, the method further comprising:
providing an entanglement device; and
the drone swarm further includes at least two entanglement drones, wherein the entanglement drones are configured to carry the entanglement device and wherein the entanglement drones include the network.

28. The method of claim 27, wherein at least two of the entanglement drones carry the entanglement device.

29. The method of claim 28, the method further comprising:
providing a central coordinating station, wherein the central coordinating station is configured to include the network, wherein the central coordinating station provides instructions to the drone swarm how to move to detect the remote object, receives the location data set and the signal data set, performs the triangulation, and provides instructions to the entanglement drones to capture the remote object.

30. The method of claim 27, wherein the entanglement device is a net.

31. A system for capturing objects, the system comprising:
a plurality of computer processors;
a plurality of computer memories;
a plurality of networking communications modules; and
a central processing station networked to the set of computer processors, wherein the computer processors are configured to perform instructions provided by a computer program stored in the computer memories to control one or more drones, wherein all or a subset of the drones fly in a geometric pattern for aggregate remote object detection, wherein all or a subset of the drones comprise an entanglement device strung between them, wherein all or a subset of the drones is equipped with image, sound, or electromagnetic detection sensors.

32. The system of claim 31, wherein each drone is controlled by providing instructions that control the speed, orientation, and/or position of the drone relative to a fixed point or relative to another drone in the drone swarm.

33. The system of claim 31 wherein the velocities of the subset of drones comprising the entanglement device are provided by said computer program to position the drones and entanglement device without entangling a drone in the entanglement device.

34. The system of claim 31 wherein the velocities of the drones are provided by said computer program to position the drones and entanglement device without a drone becoming entangled in the entanglement device.

35. The system of claim 31 wherein a central processing system is configured to process data returned by a subset of drones to determine the location of the object to be captured relative to the entanglement device.

36. The system of claim 31 wherein the set of drones is programmed by the computer program to direct the area of the entanglement device toward to capture or impede the remote object.

37. A drone sensing data collecting node comprising a sensing antenna and a network antenna.

38. The drone sensing data collecting node of claim 37 further comprising a computing module.

39. The drone sensing data collecting node of claim 37 further comprising an energy storage device.

40. The drone sensing data collecting node of claim 37 further comprising a global positioning system (GPS) device.

41. The drone sensing data collecting node of claim 37 further comprising a sensor.

42. The drone sensing data collecting node of claim 37 further comprising a microphone and a camera.

43. The drone sensing data collecting node of claim 37 further comprising a sensor to detect electromagnetic waves.

44. The drone sensing data collecting node of claim 37 comprising a processor configured to produce a drone node signal detection packet.

45. The drone sensing data collecting node of claim 37 comprising a processor configured to transmit a drone node signal detection packet by the network antenna.

46. The drone sensing data collecting node of claim 37 comprising a processor configured to perform Doppler frequency shift analysis.

47. The drone sensing data collecting node of claim 37 comprising a processor configured to perform Doppler frequency shift analysis using data collected by said sensing antenna.

48. The drone sensing data collecting node of claim 37 comprising a processor configured to detect one of a change in a magnitude of a detected signal or a shift in frequency of a detected signal.
